(19) United States
(12) Patent Application Publication
(10) Pub. No.: US 2026/0251362 A1
(43) Pub. Date: Aug. 27, 2026

(54) MAGNETIC COOLING DEVICE AND COOLING CYCLE APPARATUS

(71) Applicant: SAMSUNG ELECTRONICS CO., LTD., Suwon-si (KR)

(72) Inventors: Junwoo SUH, Suwon-si (KR); Youngno KIM, Suwon-si (KR); Minsoo KIM, Suwon-si (KR)

(21) Appl. No.: 19/548,119

(22) Filed: Feb. 24, 2026

Related U.S. Application Data
(63) Continuation of application No. PCT/KR2026/001000, filed on Jan. 16, 2026.

(30) Foreign Application Priority Data
Feb. 24, 2025 (KR) 10-2025-0023962

(51) Int. Cl. F25B 21/00

(52) U.S. Cl. CPC F25B 21/00; F25B 2321/0022

(57) ABSTRACT

A magnetic cooling device may include: a magnet configured to form a magnetic field, a magnetocaloric unit including a magnetocaloric material configured to change temperature by the magnetic field and arranged to allow a heat transfer fluid to flow therethrough, a first fluid transfer device connected to a hot side of the magnetocaloric unit and configured to transfer the heat transfer fluid using centrifugal force, and a second fluid transfer device connected to a cold side of the magnetocaloric unit and configured to transfer the heat transfer fluid using centrifugal force.

### CROSS-REFERENCE TO RELATED APPLICATIONS

This application is a continuation of International Application No. PCT/KR2026/001000 designating the United States, filed on January 16, 2026, in the Korean Intellectual Property Receiving Office and claiming priority to Korean Patent Application No. 10-2025-0023962, filed on February 24, 2025, in the Korean Intellectual Property Office, the disclosures of each of which are incorporated by reference herein in their entireties.

### BACKGROUND

### Field

The disclosure relates to a magnetic cooling device and a cooling cycle apparatus.

### Description of Related Art

Household appliances may include cooling devices to supply cool air to spaces that require cooling. For example, refrigerators require cooling devices to supply cool air to storage compartments that store food in order to keep food fresh for extended periods. For example, air conditioners require cooling devices to supply cool air to indoor spaces in order to control temperature and humidity suitable for human activity.

Conventional refrigerators and air conditioners have used cooling cycle apparatus that repeatedly compress and expand refrigerant. However, the refrigerant used in operating conventional cooling cycle apparatus may accelerate global warming. Additionally, there is a possibility of explosion due to refrigerant leakage.

Therefore, there has been demand for environmentally friendly cooling devices that do not accelerate global warming and have low explosion potential. Among these, cooling cycle apparatus utilizing magnetocaloric effects may implement environmentally friendly cooling devices, and active research has been continuing recently.

### SUMMARY

Embodiments of the disclosure provide a magnetic cooling device with a simple structure and a cooling cycle apparatus including the same.

Embodiments of the disclosure provide a magnetic cooling device that does not require pumps and valves, and a cooling cycle apparatus including the same.

Embodiments of the disclosure provide a magnetic cooling device capable of uniformly flowing heat transfer fluid and a cooling cycle apparatus including the same.

A magnetic cooling device according to an example embodiment of the present disclosure may include: a magnet configured to form a magnetic field; a magnetocaloric unit including a magnetocaloric material configured to change temperature by the magnetic field, and arranged to allow a heat transfer fluid to flow therethrough; a first fluid transfer device connected to a hot side of the magnetocaloric unit and configured to transfer the heat transfer fluid using centrifugal force; and a second fluid transfer device connected to a cold side of the magnetocaloric unit and configured to transfer the heat transfer fluid using centrifugal force, wherein the first fluid transfer device may include: a first chamber configured to be rotatable relative to the magnetocaloric unit; a first outlet connectable to an outer portion of the first chamber; and a first inlet connectable to an inner portion of the first chamber, and the second fluid transfer device may include: a second chamber configured to be rotatable relative to the magnetocaloric unit; a second outlet connectable to an outer portion of the second chamber; and a second inlet connectable to an inner portion of the second chamber.

A cooling cycle apparatus according to an example embodiment of the present disclosure may include: a first heat exchanger configured to discharge heat; a second heat exchanger configured to absorb heat; and a magnetic cooling device disposed between the first heat exchanger and the second heat exchanger and configured to operate in a first mode or a second mode. The magnetic cooling device may include: a magnetocaloric unit including a case and magnetocaloric material disposed inside the case and having temperature configured to change based on a magnetic field; a magnet configured to generate the magnetic field; a first fluid transfer device including a chamber connected to a hot side of the magnetocaloric unit and configured to transfer heat transfer fluid using centrifugal force; a second fluid transfer device including a chamber connected to a cold side of the magnetocaloric unit and configured to transfer heat transfer fluid using centrifugal force; and a rotating shaft configured to transmit rotational force to the magnet, the first fluid transfer device, and the second fluid transfer device.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example configuration of a cooling cycle apparatus according to various embodiments;

FIG. 2 is a diagram illustrating an example magnetic cooling device according to various embodiments;

FIG. 3 is a diagram illustrating an example magnetocaloric unit according to various embodiments;

FIG. 4 is an exploded perspective view of a rotating shaft, first fluid transfer device, and second fluid transfer device according to various embodiments;

FIG. 5 is an exploded perspective view of a rotating shaft, first fluid transfer device, and second fluid transfer device according to various embodiments;

FIG. 6 is a block diagram illustrating an example configuration of a magnetic cooling device according to various embodiments;

FIG. 7 is a table illustrating an example operation of a magnetic cooling device according to various embodiments;

FIG. 8 is a diagram illustrating a state in which a magnetic cooling device operates in a first mode according to various embodiments;

FIG. 9 is a diagram illustrating an example magnetocaloric unit and magnet in a first mode of a magnetic cooling device according to various embodiments;

FIG. 10 is a diagram illustrating an example first fluid transfer device in a first mode of a magnetic cooling device according to various embodiments;

FIG. 11 is a diagram illustrating an example second fluid transfer device in a first mode of a magnetic cooling device according to various embodiments;

FIG. 12 is a diagram illustrating a state in which a magnetic cooling device operates in a second mode according to various embodiments;

FIG. 13 is a diagram illustrating an example magnetocaloric unit and magnet in a second mode of a magnetic cooling device according to various embodiments;

FIG. 14 is a diagram illustrating an example first fluid transfer device in a second mode of a magnetic cooling device according to various embodiments;

FIG. 15 is a diagram illustrating an example second fluid transfer device in a second mode of a magnetic cooling device according to various embodiments;

FIG. 16 is a diagram illustrating an example first fluid transfer device in a first mode of a magnetic cooling device according to various embodiments;

FIG. 17 is a diagram illustrating an example second fluid transfer device in a first mode of a magnetic cooling device according to various embodiments;

FIG. 18 is a diagram illustrating an example first fluid transfer device in a second mode of a magnetic cooling device according to various embodiments;

FIG. 19 is a diagram illustrating an example second fluid transfer device in a second mode of a magnetic cooling device according to various embodiments;

FIG. 20 is a perspective view of a refrigerator including a cooling cycle apparatus according to various embodiments; and

FIG. 21 is a side sectional view of a refrigerator including a cooling cycle apparatus according to various embodiments.

### DETAILED DESCRIPTION

Various example embodiments of the disclosure and terms used therein are not intended to limit the technical features described in the disclosure to specific embodiments, but should be understood to include various modifications, equivalents, or substitutions.

In relation to the description of the drawings, similar reference numerals may be used for similar or related components.

The singular form of a noun corresponding to an item may include one or more of the items, unless the relevant context clearly indicates otherwise.

In the disclosure, phrases such as "A or B", "at least one of A and B", "at least one of A or B", "A, B or C", "at least one of A, B and C", and "at least one of A, B, or C" may each include any one of the items listed together in the corresponding phrase, or all possible combinations thereof.

The term "and/or" includes combinations of a plurality of related described components or any component among a plurality of related described components.

The terms "part", "module", and "member" may be implemented in hardware or software. According to embodiments, a plurality of "parts", "modules", and "members" may be implemented as one component, or one "part", "module", and "member" may include a plurality of components.

Terms such as "first", "second", or "first" or "second" may be used simply to distinguish the corresponding component from other corresponding components, and do not limit the corresponding components in other aspects (e.g., importance or order).

When a (e.g., first) component is referred to as being "coupled" or "connected" to another (e.g., second) component, with or without terms such as "functionally" or "communicatively", the component may be connected to the other component directly (e.g., by wire), wirelessly, or through a third component.

Terms such as "include" or "have" are intended to indicate that features, numbers, steps, operations, components, parts, or combinations thereof described in the disclosure exist, and do not preclude the existence or addition of one or more other features, numbers, steps, operations, components, parts, or combinations thereof.

When a component is said to be "connected", "coupled", "supported", or "in contact" with another component, this includes not only cases where the components are directly connected, coupled, supported, or in contact, but also cases where they are indirectly connected, coupled, supported, or in contact through a third component.

When a component is positioned "on" another component, this includes not only cases where the component is in contact with the other component, but also cases where another component exists between the two components.

The term "identical" includes things that are similar to each other in properties or similar within a certain range. The term “identical” may be understood to include "substantially identical". Substantially identical should be understood to include numerical values corresponding to manufacturing tolerances or differences within ranges that do not have meaning relative to reference values as falling within the scope of "identical".

Various example embodiments according to the present disclosure will be described in greater detail below with reference to the accompanying drawings.

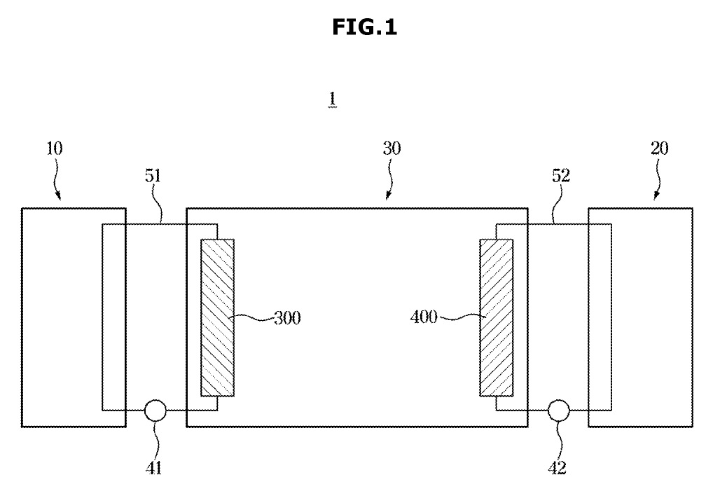

FIG. 1 is a diagram illustrating an example configuration of a cooling cycle apparatus according to various embodiments.

Referring to FIG. 1, a cooling cycle apparatus 1 may include a first heat exchanger 10 and a second heat exchanger 20. The first heat exchanger 10 may be configured to discharge heat. The second heat exchanger 20 may be configured to absorb heat.

For example, when a household appliance including the cooling cycle apparatus 1 is a refrigerator, the first heat exchanger 10 may discharge heat to outside the storage compartment, and the second heat exchanger 20 may absorb heat from air flowing to the storage compartment.

For example, when a household appliance including the cooling cycle apparatus 1 is an air conditioner, the first heat exchanger 10 may be provided in an outdoor unit to discharge heat to outside the outdoor unit, and the second heat exchanger 20 may be provided in an indoor unit to absorb heat from air flowing indoors.

The cooling cycle apparatus 1 may include a magnetic cooling device 30. The magnetic cooling device 30 may be disposed between the first heat exchanger 10 and the second heat exchanger 20. The magnetic cooling device 30 may be configured to exchange heat with the first heat exchanger 10. The magnetic cooling device 30 may be configured to exchange heat with the second heat exchanger 20.

Heat transfer fluid may flow within the magnetic cooling device 30. The magnetic cooling device 30 may be configured to cool or heat the heat transfer fluid. The heat transfer fluid may not be a refrigerant, and water may be used as the heat transfer fluid, for example.

The magnetic cooling device 30 may include at least one fluid transfer device 300 and/or 400. The at least one fluid transfer device 300 and/or 400 may be configured to transfer heat transfer fluid. The at least one fluid transfer device 300 and/or 400 may cause heat transfer fluid to flow within the magnetic cooling device 30. For example, the heat transfer fluid may be configured to circulate within the magnetic cooling device 30 by the at least one fluid transfer device 300 and/or 400.

The magnetic cooling device 30 may include a first fluid transfer device 300. The first fluid transfer device 300 may be configured to perform heat exchange with the first heat exchanger 10. The first fluid transfer device 300 may be configured to accommodate heated heat transfer fluid. The first fluid transfer device 300 may discharge heat toward the first heat exchanger 10.

The first fluid transfer device 300 may also be referred to as a first fluid moving device 300, first fluid delivery device 300, first fluid supply device 300, first fluid injection device 300, or the like.

For example, the cooling cycle apparatus 1 may include a first heat transfer pipe 51. A first working fluid may flow through the first heat transfer pipe 51 and be configured to transfer heat between the first heat exchanger 10 and the first fluid transfer device 300. Heat generated in the first fluid transfer device 300 may move to the first heat exchanger 10 through the first working fluid. The first heat transfer pipe 51 may have a closed loop shape. The first working fluid may not be a refrigerant, and water may be used as the first working fluid, for example.

For example, the cooling cycle apparatus 1 may include a first pump 41 disposed on the first heat transfer pipe 51. The first pump 41 may cause the first working fluid to flow along the first heat transfer pipe 51.

For example, the cooling cycle apparatus 1 may not include the first heat transfer pipe 51 and first pump 41. A first fan may be disposed between the first heat exchanger 10 and the magnetic cooling device 30, and heat from the first fluid transfer device 300 may be transferred to the first heat exchanger 10 by the blowing force of the first fan. For example, the cooling cycle apparatus 1 may include all of the first heat transfer pipe 51, first pump 41, and first fan.

The magnetic cooling device 30 may include a second fluid transfer device 400. The second fluid transfer device 400 may be configured to perform heat exchange with the second heat exchanger 20. The second fluid transfer device 400 may be configured to accommodate cooled heat transfer fluid. The second fluid transfer device 400 may absorb heat from the second heat exchanger 20.

The second fluid transfer device 400 may also be referred to as a second fluid moving device 400, second fluid delivery device 400, second fluid supply device 400, second fluid injection device 400, or the like.

For example, the cooling cycle apparatus 1 may include a second heat transfer pipe 52. A second working fluid may flow through the second heat transfer pipe 52 and be configured to transfer heat between the second heat exchanger 20 and the second fluid transfer device 400. Heat generated in the second heat exchanger 20 may move to the second fluid transfer device 400 through the second working fluid. The second heat transfer pipe 52 may have a closed loop shape. The second working fluid may not be a refrigerant, and water may be used as the second working fluid, for example.

For example, the cooling cycle apparatus 1 may include a second pump 42 disposed on the second heat transfer pipe 52. The second pump 42 may cause the second working fluid to flow along the second heat transfer pipe 52.

For example, the cooling cycle apparatus 1 may not include the second heat transfer pipe 52 and second pump 42. A second fan may be disposed between the second heat exchanger 20 and the magnetic cooling device 30, and heat from the second heat exchanger 20 may be transferred to the second fluid transfer device 400 by the blowing force of the second fan. For example, the cooling cycle apparatus 1 may include all of the second heat transfer pipe 52, second pump 42, and second fan.

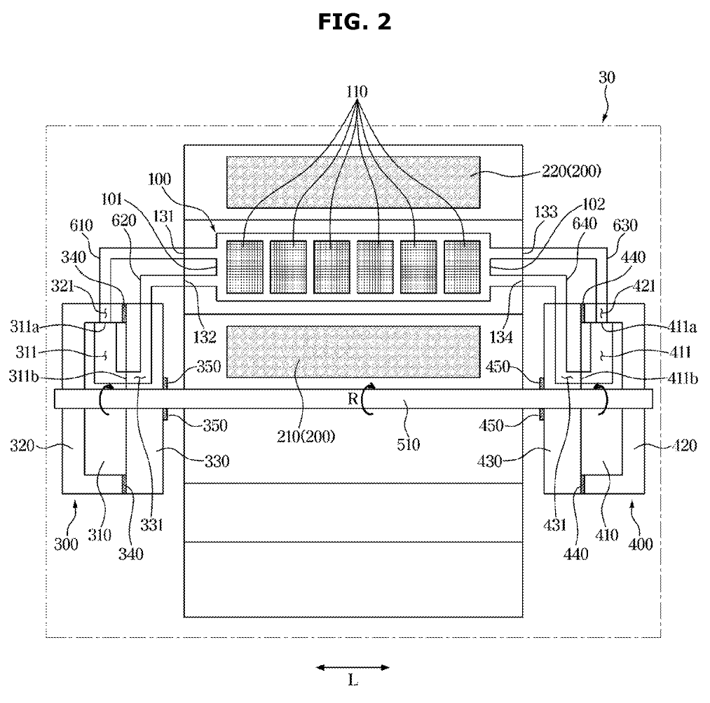

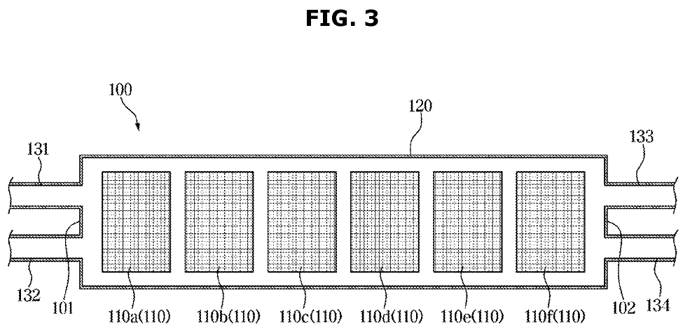

FIG. 2 is a diagram illustrating an example magnetic cooling device according to various embodiments. FIG. 3 is a diagram illustrating an example magnetocaloric unit according to various embodiments.

For reference, FIG. 2 illustrates an example where the magnetic cooling device 30 includes one magnetocaloric unit 100 and one magnet 200 for ease of description. However, the magnetic cooling device 30 shown in FIG. 2 an example of the present disclosure, and the magnetic cooling device 30 may include at least one magnetocaloric unit 100 and at least one magnet 200.

A magnetic cooling device 30 according to an embodiment of the present disclosure may include a magnetocaloric unit 100, a magnet 200, a first fluid transfer device 300, and a second fluid transfer device 400.

The magnetocaloric unit 100 may be configured to allow heat transfer fluid to flow. The heat transfer fluid may be heated or cooled while passing through the magnetocaloric unit 100. The temperature of the heat transfer fluid may increase or decrease while passing through the magnetocaloric unit 100.

The magnetocaloric unit 100 may utilize the magnetocaloric effect. The magnetocaloric effect may refer to an effect where magnetic moments within a magnetic material align in the direction of the magnetic field and the temperature of the magnetic material changes, in response to applying a magnetic field to the magnetic material. The magnetocaloric unit 100 may increase the temperature of the heat transfer fluid using the magnetocaloric effect. The magnetocaloric unit 100 may heat the heat transfer fluid using the magnetocaloric effect. The magnetocaloric unit 100 may decrease the temperature of the heat transfer fluid using the magnetocaloric effect. The magnetocaloric unit 100 may cool the heat transfer fluid using the magnetocaloric effect. The magnetocaloric unit 100 may be referred to as a magnetocaloric device, magnetocaloric module, magnetocaloric body, or the like. The magnetocaloric unit 100 may be referred to as an Active Magnetic Regenerator bed (AMR bed).

The magnetocaloric unit 100 may include magnetocaloric material 110. The magnetocaloric material 110 may be a material that may utilize the magnetocaloric effect. The magnetocaloric material 110 may change temperature as magnetic moments within the magnetocaloric material 110 align in response to application of a magnetic field. The magnetocaloric material 110 may change temperature based on the magnetic field.

For example, the magnetocaloric material 110 may include materials having magnetocaloric effects, such as gadolinium, iron-based alloys, and rare earth metal alloys. However, the present disclosure is not limited to the above examples, and the magnetocaloric material 110 may include various materials having magnetocaloric effects.

The magnetocaloric material 110 may include a plurality of magnetocaloric blocks 110a, 110b, 110c, 110d, 110e, 110f. Each of the plurality of magnetocaloric blocks 110a, 110b, 110c, 110d, 110e, 110f may be made of material capable of utilizing the magnetocaloric effect. Each of the plurality of magnetocaloric blocks 110a, 110b, 110c, 110d, 110e, 110f may have a porous structure.

The plurality of magnetocaloric blocks 110a, 110b, 110c, 110d, 110e, 110f may have different Curie temperatures. The plurality of magnetocaloric blocks 110a, 110b, 110c, 110d, 110e, 110f having different Curie temperatures may be heated or cooled to different temperatures depending on application or removal of the magnetic field. That is, the magnetocaloric material 110 may include the plurality of magnetocaloric blocks 110a, 110b, 110c, 110d, 110e, 110f having different Curie temperatures, thereby widening the temperature range of the magnetocaloric material 110. The temperature range of the heat transfer fluid flowing through the magnetocaloric material 110 may also be widened. Consequently, the magnetocaloric effect of the magnetocaloric material 110 may be enhanced.

The plurality of magnetocaloric blocks 110a, 110b, 110c, 110d, 110e, 110f may be arranged spaced apart. This is because heat loss due to conduction may occur when magnetocaloric blocks having different Curie temperatures contact each other. For example, the plurality of magnetocaloric blocks 110a, 110b, 110c, 110d, 110e, 110f may be arranged spaced apart along the movement direction of the heat transfer fluid.

When a magnetic field is repeatedly applied to and removed from the magnetocaloric unit 100, a temperature distribution may be formed asymmetrically. That is, a thermal gradient may occur in the magnetocaloric unit 100. Thus, one side of the magnetocaloric unit 100 may form a hot side 101, and the other side of the magnetocaloric unit 100 may form a cold side 102.

The magnetocaloric unit 100 may include a case 120. The case 120 may be configured to accommodate the magnetocaloric material 110. The case 120 may form an internal space, and the magnetocaloric material 110 may be disposed in the internal space of the case 120. Heat transfer fluid may flow in the internal space of the case 120.

The magnetocaloric unit 100 may include a first port 131. The first port 131 may be formed on the hot side 101 of the magnetocaloric unit 100. The first port 131 may be connected to a first outlet 321 of the first fluid transfer device 300. For example, the first port 131 may be connected to the first outlet 321 of the first fluid transfer device 300 through a first connection pipe 610.

The magnetocaloric unit 100 may include a second port 132. The second port 132 may be formed on the hot side 101 of the magnetocaloric unit 100. The second port 132 may be connected to a first inlet 331 of the first fluid transfer device 300. For example, the second port 132 may be connected to the first inlet 331 of the first fluid transfer device 300 through a second connection pipe 620.

The magnetocaloric unit 100 may include a third port 133. The third port 133 may be formed on the cold side 102 of the magnetocaloric unit 100. The third port 133 may be connected to a second outlet 421 of the second fluid transfer device 300. For example, the third port 133 may be connected to the second outlet 421 of the second fluid transfer device 400 through a third connection pipe 630.

The magnetocaloric unit 100 may include a fourth port 134. The fourth port 134 may be formed on the cold side 102 of the magnetocaloric unit 100. The fourth port 134 may be connected to a second inlet 431 of the second fluid transfer device 300. For example, the fourth port 134 may be connected to the second inlet 431 of the second fluid transfer device 400 through a fourth connection pipe 640.

The magnetocaloric unit 100 may include a magnet 200. The magnet 200 may be disposed between the first fluid transfer device 300 and the second fluid transfer device 400.

The magnet 200 may be configured to form a magnetic field. The magnet 200 may or may not apply a magnetic field to the magnetocaloric unit 100. The magnet 200 may or may not apply a magnetic field to the magnetocaloric material 110. The magnetocaloric material 110 may be arranged to be exposed or not exposed to the magnetic field formed by the magnet 200. When the magnetocaloric material 110 receives a magnetic field from the magnet 200, the temperature of the magnetocaloric material 110 may increase. When the magnetocaloric material 110 does not receive a magnetic field from the magnet 200, the temperature of the magnetocaloric material 110 may decrease.

When the magnet 200 applies a magnetic field to the magnetocaloric material 110, it may be referred to as a magnetic field ON state. When the magnet 200 does not apply a magnetic field to the magnetocaloric material 110, it may be referred to as a magnetic field OFF state.

The magnet 200 may be configured to be rotatable relative to the magnetocaloric unit 100. The magnet 200 may be configured to apply or not apply a magnetic field to the magnetocaloric material 110 as it rotates. The magnet 200 may rotate R by a rotating shaft 510, which will be described in greater detail below.

The magnet 200 may include a first pole portion 210 and a second pole portion 220 having polarity opposite to that of the first pole portion 210. A magnetic field may be formed in a direction from the first pole portion 210 toward the second pole portion 220 or from the second pole portion 220 toward the first pole portion 210.

The first fluid transfer device 300 may be connected to the hot side 101 of the magnetocaloric unit 100. The first fluid transfer device 300 may be configured to transfer heat transfer fluid using centrifugal force. The first fluid transfer device 300 may supply heat transfer fluid to the magnetocaloric unit 100 using centrifugal force. The first fluid transfer device 300 may receive heat transfer fluid discharged from the magnetocaloric unit 100.

The first fluid transfer device 300 may include a first chamber 311. The first chamber 311 may be arranged to be able to accommodate heat transfer fluid. The first chamber 311 may be a predetermined space formed inside the first fluid transfer device 300.

The first chamber 311 may be configured to be rotatable relative to the magnetocaloric unit 100. Centrifugal force may be generated as the first chamber 311 rotates. Heat transfer fluid in the first chamber 311 may be discharged from the first chamber 311 toward the magnetocaloric unit 100 by centrifugal force. The first chamber 311 may rotate R by the rotating shaft 510.

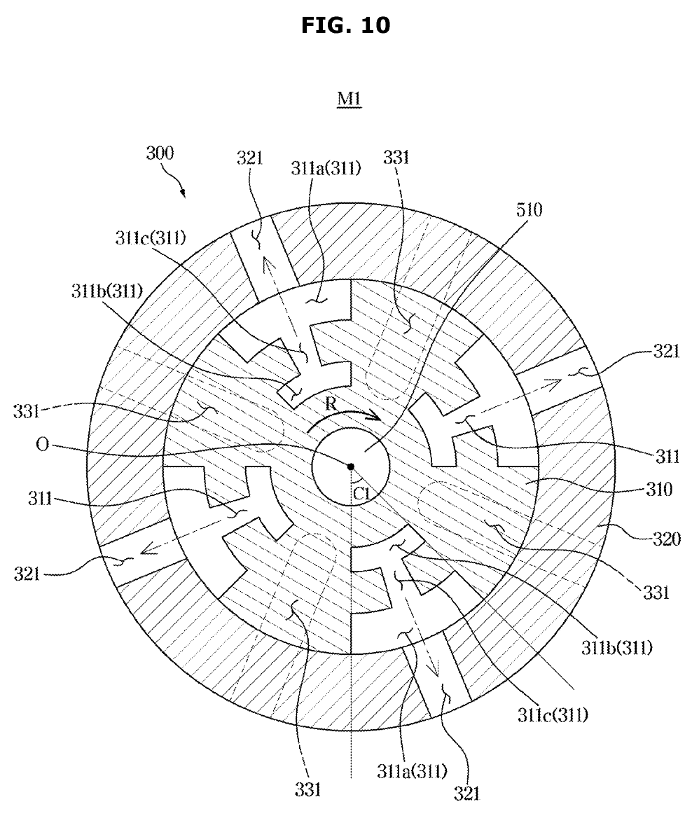

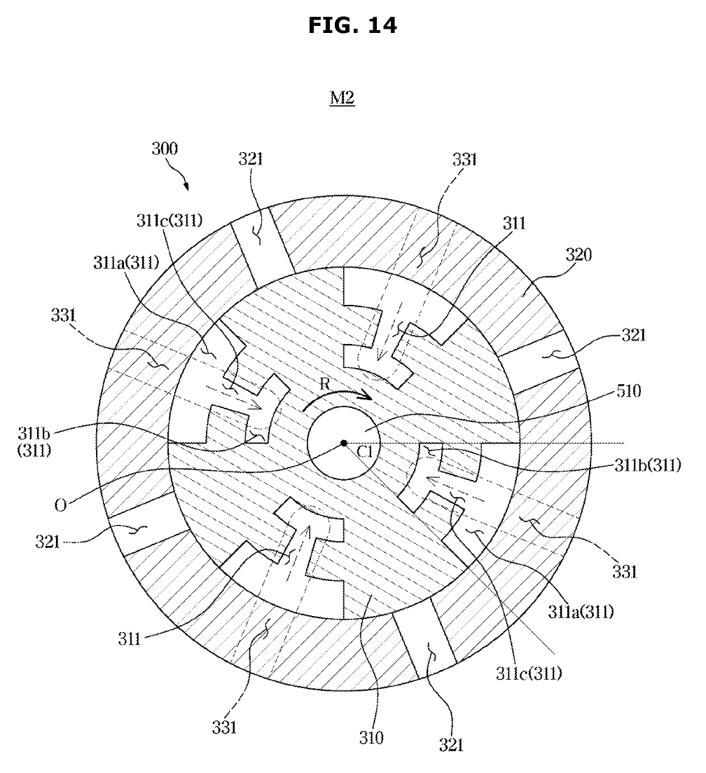

The first chamber 311 may include an outer portion 311a and an inner portion 311b. The outer portion 311a of the first chamber 311 and the inner portion 311b of the first chamber 311 may be spaced apart along the radial direction. The outer portion 311a of the first chamber 311 may be spaced radially outward from the inner portion 311b of the first chamber 311. The inner portion 311bof the first chamber 311 may be a portion adjacent to the rotation center O (see, e.g., FIGS. 10 and 14), and the outer portion 311a of the first chamber 311 may be a portion far from the rotation center O. The inner portion 311b of the first chamber 311 may be adjacent to the center of the first rotating frame 310, and the outer portion 311a of the first chamber 311 may be formed at the outer part of the first rotating frame 310. The first chamber 311 may include a connecting portion 311c (see FIGS. 10 and 14) connecting the outer portion 311a and the inner portion 311b.

The first fluid transfer device 300 may include a first rotating frame 310. The first chamber 311 may be formed in the first rotating frame 310. The first rotating frame 310 will be described in greater detail below.

The first fluid transfer device 300 may include a first outlet 321. The first outlet 321 may be configured to be connectable to the first chamber 311. The first outlet 321 may be configured to be connectable to the outer portion 311a of the first chamber 311. The first outlet 321 may be configured to selectively communicate with the first chamber 311. Depending on the mode of the magnetic cooling device 30, the first outlet 321 may be arranged to communicate or not communicate with the outer portion 311a of the first chamber 311. While the first chamber 311 is rotatable relative to the magnetocaloric unit 100, the first outlet 321 may remain fixed without rotating relative to the magnetocaloric unit 100. This may cause the first outlet 321 to communicate with or be blocked from the outer portion 311a of the first chamber 311 in response to rotation of the first chamber 311. When the first outlet 321 communicates with the first chamber 311, the first outlet 321 may be referred to as OPEN. When the first outlet 321 does not communicate with the first chamber 311, the first outlet 321 may be referred to as CLOSED.

The first fluid transfer device 300 may include a first fixed frame 320. The first outlet 321 may be formed in the first fixed frame 320. A more detailed description of the first fixed frame 320 will be provided below.

The first fluid transfer device 300 may include a first inlet 331. The first inlet 331 may be configured to be connectable to the first chamber 311. The first inlet 331 may be configured to be connectable to the inner portion 311b of the first chamber 311. The first inlet 331 may be configured to selectively communicate with the first chamber 311. Depending on the mode of the magnetic cooling device 30, the first inlet 331 may be arranged to communicate or not communicate with the inner portion 311b of the first chamber 311. While the first chamber 311 is rotatable relative to the magnetocaloric unit 100, the first inlet 331 may remain fixed without rotating relative to the magnetocaloric unit 100. Due to this, the first inlet 331 may communicate with or be blocked from the inner portion 311b of the first chamber 311 according to rotation of the first chamber 311. When the first inlet 331 communicates with the first chamber 311, the first inlet 331 may be referred to as OPEN. When the first inlet 331 does not communicate with the first chamber 311, the first inlet 331 may be referred to as CLOSED.

The first fluid transfer device 300 may include a second fixed frame 330. The first inlet 331 may be formed in the second fixed frame 330. A more detailed description of the second fixed frame 330 will be provided below.

The second fluid transfer device 400 may be connected to the cold side 102 of the magnetocaloric unit 100. The second fluid transfer device 400 may be configured to transfer heat transfer fluid using centrifugal force. The second fluid transfer device 400 may supply heat transfer fluid to the magnetocaloric unit 100 using centrifugal force. The second fluid transfer device 400 may receive heat transfer fluid discharged from the magnetocaloric unit 100.

The second fluid transfer device 400 may include a second chamber 411. The second chamber 411 may be arranged to be able to accommodate heat transfer fluid. The second chamber 411 may be a predetermined (e.g., specified) space formed inside the second fluid transfer device 400.

The second chamber 411 may be configured to be rotatable relative to the magnetocaloric unit 100. Centrifugal force may be generated as the second chamber 411 rotates. Heat transfer fluid in the second chamber 411 may be discharged from the second chamber 411 toward the magnetocaloric unit 100 by centrifugal force. The second chamber 411 may rotate R by the rotating shaft 510.

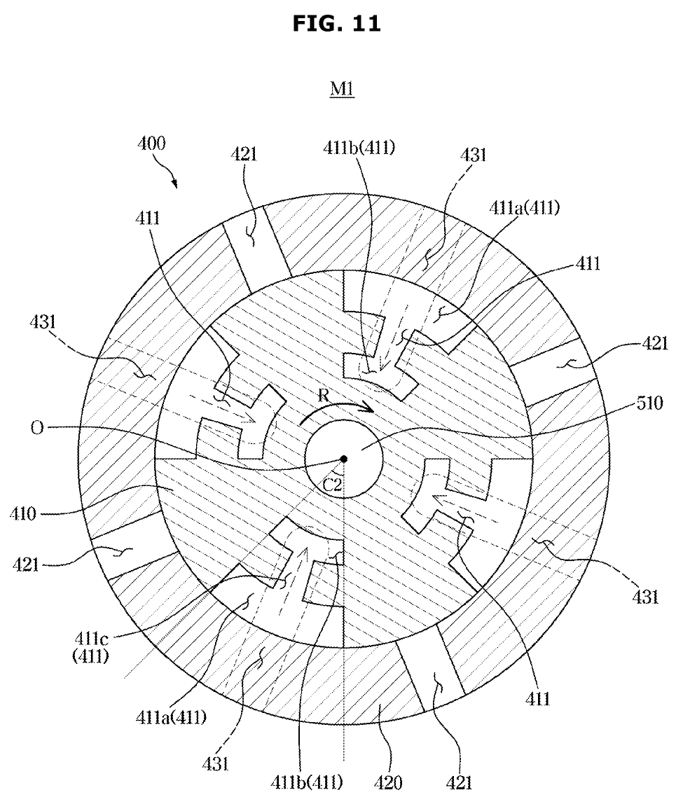

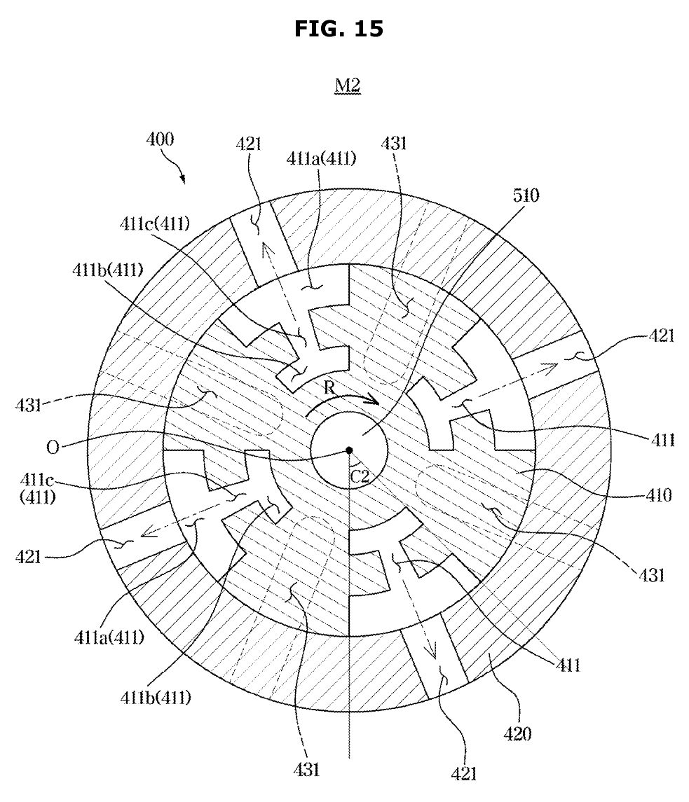

The second chamber 411 may include an outer portion 411a and an inner portion 411b. The outer portion 411a of the second chamber 411 and the inner portion 411b of the second chamber 411 may be spaced apart along the radial direction. The outer portion 411a of the second chamber 411 may be spaced radially outward from the inner portion 411b of the second chamber 411. The inner portion 411b of the second chamber 411 may be a portion adjacent to the rotation center O of the second chamber 411 (see FIGS. 11 and 15), and the outer portion 411a of the second chamber 411 may be a portion far from the rotation center of the second chamber 411. The inner portion 411b of the second chamber 411 may be adjacent to the center of the second rotating frame 410, and the outer portion 411a of the second chamber 411 may be formed at the outer part of the second rotating frame 410. The second chamber 411 may include a connecting portion 411c (see FIGS. 11 and 15) connecting the outer portion 411a and the inner portion 411b.

The second fluid transfer device 400 may include a second rotating frame 410. The second chamber 411 may be formed in the second rotating frame 410. A more detailed description of the second rotating frame 410 will be provided below.

The second fluid transfer device 400 may include a second outlet 421. The second outlet 421 may be configured to be connectable to the second chamber 411. The second outlet 421 may be configured to be connectable to the outer portion 411a of the second chamber 411. The second outlet 421 may be configured to selectively communicate with the second chamber 411. Depending on the mode of the magnetic cooling device 30, the second outlet 421 may be arranged to communicate or not communicate with the outer portion 411a of the second chamber 411. While the second chamber 411 is rotatable relative to the magnetocaloric unit 100, the second outlet 421 may remain fixed without rotating relative to the magnetocaloric unit 100. This may cause the second outlet 421 to communicate with or be blocked from the outer portion 411a of the second chamber 411 in response to rotation of the second chamber 411. When the second outlet 421 communicates with the second chamber 411, the second outlet 421 may be referred to as OPEN. When the second outlet 421 does not communicate with the second chamber 411, the second outlet 421 may be referred to as CLOSED.

The second fluid transfer device 400 may include a third fixed frame 420. The second outlet 421 may be formed in the third fixed frame 420. A more detailed description of the third fixed frame 420 will be provided below.

The second fluid transfer device 400 may include a second inlet 431. The second inlet 431 may be configured to be connectable to the second chamber 411. The second inlet 431 may be configured to be connectable to the inner portion 411b of the second chamber 411. The second inlet 431 may be configured to selectively communicate with the second chamber 411. Depending on the mode of the magnetic cooling device 30, the second inlet 431 may be arranged to communicate or not communicate with the inner portion 411b of the second chamber 411. While the second chamber 411 is rotatable relative to the magnetocaloric unit 100, the second inlet 431 may remain fixed without rotating relative to the magnetocaloric unit 100. This may cause the second inlet 431 to communicate with or be blocked from the inner portion 411b of the second chamber 411 in response to rotation of the second chamber 411. When the second inlet 431 communicates with the second chamber 411, the second inlet 431 may be referred to as OPEN. When the second inlet 431 does not communicate with the second chamber 411, the second inlet 431 may be referred to as CLOSED.

The second fluid transfer device 400 may include a fourth fixed frame 430. The second inlet 431 may be formed in the fourth fixed frame 430. A more detailed description of the fourth fixed frame 430 will be provided below.

The rotation of the magnet 200, first chamber 311, and second chamber 411 may be configured to be synchronized. The magnet 200, first chamber 311, and second chamber 411 may be arranged to rotate together. For example, the magnet 200, first chamber 311, and second chamber 411 may rotate in the same rotational direction and at the same rotational speed.

The magnetic cooling device 30 may include a rotating shaft 510. The rotating shaft 510 may be configured to transmit rotational force to the magnet 200, first fluid transfer device 300, and second fluid transfer device 400. The rotating shaft 510 may be configured to rotate the magnet 200, first chamber 311, and second chamber 411 together. As the rotating shaft 510 rotates R, the magnet 200, first chamber 311, and second chamber 411 may rotate.

The first fluid transfer device 300, magnet 200, and second fluid transfer device 400 may be arranged along the longitudinal direction L of the rotating shaft 510. The first fluid transfer device 300 and second fluid transfer device 400 may be disposed with the magnet 200 therebetween.

The magnetic cooling device 30 may include a first sealing member (e.g., including a seal) 340 disposed between the first fixed frame 320 and the second fixed frame 330. The first sealing member 340 may prevent/reduce leakage of heat transfer fluid in the first fluid transfer device 300 through the gap between the first fixed frame 320 and the second fixed frame 330.

The magnetic cooling device 30 may include a second sealing member (e.g., including a seal) 350 disposed on the outer surface of the rotating shaft 510. The second sealing member 350 may prevent/reduce leakage of heat transfer fluid in the first fluid transfer device 300 through the gap between the first fluid transfer device 300 and the rotating shaft 510.

The magnetic cooling device 30 may include a third sealing member (e.g., including a seal) 440 disposed between the third fixed frame 420 and the fourth fixed frame 430. The third sealing member 440 may prevent/reduce leakage of heat transfer fluid in the second fluid transfer device 400 through the gap between the third fixed frame 420 and the fourth fixed frame 430.

The magnetic cooling device 30 may include a fourth sealing member (e.g., including a seal) 450 disposed on the outer surface of the rotating shaft 510. The fourth sealing member 450 may prevent/reduce leakage of heat transfer fluid in the second fluid transfer device 400 through the gap between the second fluid transfer device 400 and the rotating shaft 510.

The magnetic cooling device 30 may include a first connection pipe 610. The first connection pipe 610 may connect the first port 131 of the magnetocaloric unit 100 and the first outlet 321 of the first fluid transfer device 300. The first connection pipe 610 may guide heat transfer fluid between the magnetocaloric unit 100 and the first fluid transfer device 300.

The magnetic cooling device 30 may include a second connection pipe 620. The second connection pipe 620 may connect the second port 132 of the magnetocaloric unit 100 and the first inlet 331 of the first fluid transfer device 300. The second connection pipe 620 may guide heat transfer fluid between the magnetocaloric unit 100 and the first fluid transfer device 300.

The magnetic cooling device 30 may include a third connection pipe 630. The third connection pipe 630 may connect the third port 133 of the magnetocaloric unit 100 and the second outlet 421 of the second fluid transfer device 400. The third connection pipe 630 may guide heat transfer fluid between the magnetocaloric unit 100 and the second fluid transfer device 400.

The magnetic cooling device 30 may include a fourth connection pipe 640. The fourth connection pipe 640 may connect the fourth port 134 of the magnetocaloric unit 100 and the second inlet 431 of the second fluid transfer device 400. The fourth connection pipe 640 may guide heat transfer fluid between the magnetocaloric unit 100 and the second fluid transfer device 400.

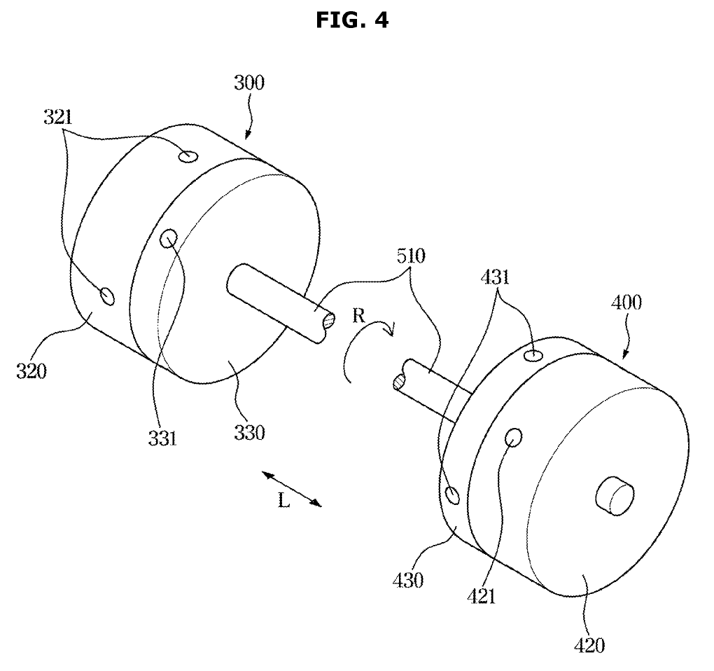

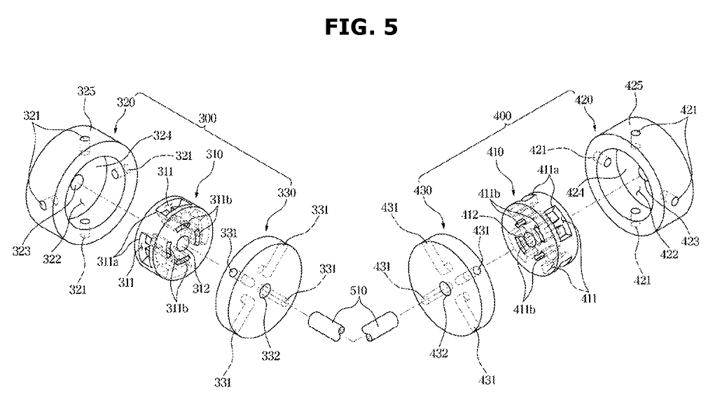

FIG. 4 is an exploded perspective view of a rotating shaft, first fluid transfer device, and second fluid transfer device according to various embodiments. FIG. 5 is an exploded perspective view of a rotating shaft, first fluid transfer device, and second fluid transfer device according to various embodiments.

Referring to FIGS. 4 and 5, the rotating shaft 510 may be configured to be couplable to the first fluid transfer device 300 and the second fluid transfer device 400. For example, the rotating shaft 510 may be coupled to the center of the first fluid transfer device 300 and the center of the second fluid transfer device 400. The first fluid transfer device 300 and the second fluid transfer device 400 may be arranged spaced apart along the longitudinal direction L of the rotating shaft 510.

The first fluid transfer device 300 may include a first rotating frame 310, a first fixed frame 320, and a second fixed frame 330. For example, the first rotating frame 310 may be surrounded by the first fixed frame 320 and the second fixed frame 330 and may not be exposed outside the first fluid transfer device 300.

The first rotating frame 310 may include a first chamber 311. The first chamber 311 may be formed penetrating a portion of the first rotating frame 310.

For example, the first rotating frame 310 may include a plurality of first chambers 311. The plurality of first chambers 311 may be arranged spaced apart along the circumferential direction. Each of the plurality of first chambers 311 may include an outer portion 311aand an inner portion 311b. Each of the plurality of first chambers 311 may include a connecting portion 311c. However, according to the present disclosure, there is no limitation on the number of first chambers 311, and the first rotating frame 310 may include a single first chamber 311.

The first rotating frame 310 may be configured to be rotatable. The first rotating frame 310 may be coupled to the rotating shaft 510 and configured to be rotated by the rotating shaft 510. Accordingly, the first chamber 311 formed in the first rotating frame 310 may also be configured to be rotated by the rotating shaft 510.

The first rotating frame 310 may include a first shaft coupling portion 312 to which the rotating shaft 510 is coupled. The first shaft coupling portion 312 may be formed at the center of the first rotating frame 310.

The first fixed frame 320 may be configured to accommodate the first rotating frame 310. The first fixed frame 320 may form a first accommodation space 322 where the first rotating frame 310 may be disposed. For example, the first fixed frame 320 may include a first body portion 324 and a first sidewall portion 325 extending from an edge portion of the first body portion 324. The first body portion 324 may have an approximately disc shape, and the first sidewall portion 325 may have a hollow cylindrical shape. The first accommodation space 322 may be a space defined by the first body portion 324 and the first sidewall portion 325.

The first fixed frame 320 may include a first outlet 321. The first outlet 321 may be formed penetrating a portion of the first fixed frame 320. The first outlet 321 may be formed in the first sidewall portion 325. The first outlet 321 may extend in the radial direction.

For example, the first fluid transfer device 300 may include a plurality of first outlets 321. The plurality of first outlets 321 may be arranged spaced apart along the circumferential direction. Each of the plurality of first outlets 321 may be configured to be connectable to each outer portion 311a of the plurality of first chambers 311. The plurality of first outlets 321 and the plurality of first chambers 311 may be arranged to correspond one-to-one.

The first fixed frame 320 may be configured not to rotate. The first fixed frame 320 may support the first rotating frame 310 that is rotated by the rotating shaft 510.

The first fixed frame 320 may include a second shaft coupling portion 323 to which the rotating shaft 510 is coupled. The second shaft coupling portion 323 may be formed at the center of the first fixed frame 320.

The second fixed frame 330 may be configured to cover the first rotating frame 310 accommodated in the first fixed frame 320. For example, the second fixed frame 330 may have an approximately or substantially disc shape.

The second fixed frame 330 may include a first inlet 331. The first inlet 331 may be formed penetrating a portion of the second fixed frame 330. The first inlet 331 may have a shape extending in the radial direction.

For example, the first fluid transfer device 300 may include a plurality of first inlets 331. The plurality of first inlets 331 may be arranged spaced apart along the circumferential direction. Each of the plurality of first inlets 331 may be configured to be connectable to each inner portion 311b of the plurality of first chambers 311. The plurality of first inlets 331 and the plurality of first chambers 311 may be arranged to correspond one-to-one.

The second fixed frame 330 may be configured not to rotate. The second fixed frame 330 may support the first rotating frame 310 that is rotated by the rotating shaft 510.

The second fixed frame 330 may include a third shaft coupling portion 332 to which the rotating shaft 510 is coupled. The third shaft coupling portion 332 may be formed at the center of the second fixed frame 330.

The second fluid transfer device 400 may include a second rotating frame 410, a third fixed frame 420, and a fourth fixed frame 430. For example, the second rotating frame 410 may be surrounded by the third fixed frame 420 and the fourth fixed frame 430 and may not be exposed outside the second fluid transfer device 400.

The second rotating frame 410 may include a second chamber 411. The second chamber 411 may be formed penetrating a portion of the second rotating frame 410.

For example, the second rotating frame 410 may include a plurality of second chambers 411. The plurality of second chambers 411 may be arranged spaced apart along the circumferential direction. Each of the plurality of second chambers 411 may include an outer portion 411a and an inner portion 411b. Each of the plurality of second chambers 411 may include a connecting portion 411c. However, according to the present disclosure, there is no limitation on the number of second chambers 411, and the second rotating frame 410 may include a single second chamber 411.

The second rotating frame 410 may be configured to be rotatable. The second rotating frame 410 may be coupled to the rotating shaft 510 and configured to be rotated by the rotating shaft 510. Accordingly, the second chamber 411 formed in the second rotating frame 410 may also be configured to be rotated by the rotating shaft 510.

The second rotating frame 410 may include a fourth shaft coupling portion 412 to which the rotating shaft 510 is coupled. The fourth shaft coupling portion 412 may be formed at the center of the second rotating frame 410.

The third fixed frame 420 may be configured to accommodate the second rotating frame 410. The third fixed frame 420 may form a second accommodation space 422 where the second rotating frame 410 may be disposed. For example, the third fixed frame 420 may include a second body portion 424 and a second sidewall portion 425 extending from an edge portion of the second body portion 424. The second body portion 424 may have an approximately disc shape, and the second sidewall portion 425 may have a hollow cylindrical shape. The second accommodation space 422 may be a space defined by the second body portion 424 and the second sidewall portion 425.

The third fixed frame 420 may include a second outlet 421. The second outlet 421 may be formed penetrating a portion of the third fixed frame 420. The second outlet 421 may be formed in the second sidewall portion 425. The second outlet 421 may extend in the radial direction.

For example, the second fluid transfer device 400 may include a plurality of second outlets 421. The plurality of second outlets 421 may be arranged spaced apart along the circumferential direction. Each of the plurality of second outlets 421 may be configured to be connectable to each outer portion 411a of the plurality of second chambers 411. The plurality of second outlets 421 and the plurality of second chambers 411 may be arranged to correspond one-to-one.

The third fixed frame 420 may be configured not to rotate. The third fixed frame 420 may support the second rotating frame 410 that is rotated by the rotating shaft 510.

The third fixed frame 420 may include a fifth shaft coupling portion 423 to which the rotating shaft 510 is coupled. The fifth shaft coupling portion 423 may be formed at the center of the third fixed frame 420.

The fourth fixed frame 430 may be configured to cover the second rotating frame 410 accommodated in the third fixed frame 420. For example, the fourth fixed frame 430 may have an approximately or substantially disc shape.

The fourth fixed frame 430 may include a second inlet 431. The second inlet 431 may be formed penetrating a portion of the fourth fixed frame 430. The second inlet 431 may have a shape extending in the radial direction.

For example, the second fluid transfer device 400 may include a plurality of second inlets 431. The plurality of second inlets 431 may be arranged spaced apart along the circumferential direction. Each of the plurality of second inlets 431 may be configured to be connectable to each inner portion 411b of the plurality of second chambers 411. The plurality of second inlets 431 and the plurality of second chambers 411 may be arranged to correspond one-to-one.

The fourth fixed frame 430 may be configured not to rotate. The fourth fixed frame 430 may support the second rotating frame 410 that is rotated by the rotating shaft 510.

The fourth fixed frame 430 may include a sixth shaft coupling portion 432 to which the rotating shaft 510 is coupled. The sixth shaft coupling portion 432 may be formed at the center of the fourth fixed frame 430.

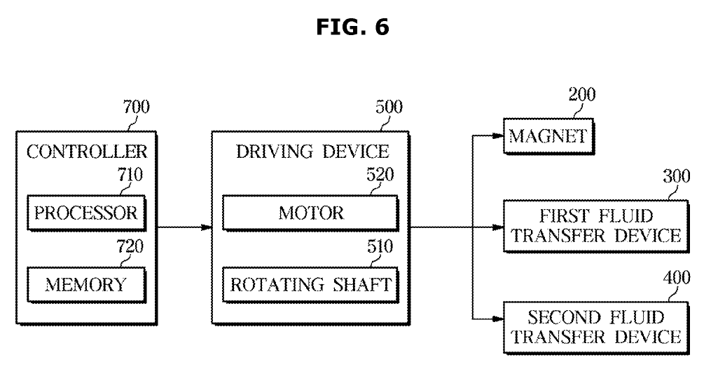

FIG. 6 is a block diagram illustrating an example configuration of a magnetic cooling device according to various embodiments.

Referring to FIG. 6, a magnetic cooling device 30 according to an embodiment of the present disclosure may include a controller (e.g., including circuitry) 700, a driving device (e.g., including a motor) 500, a magnet 200, a first fluid transfer device (e.g., including a chamber) 300, and a second fluid transfer device (e.g., including a chamber) 400.

A magnetic cooling device 30 according to an embodiment of the present disclosure may not include some of the components shown in FIG. 6. A magnetic cooling device 30 according to an embodiment of the present disclosure may include additional components other than those shown in FIG. 6.

The controller 700 may include various circuitry and control the operation of the magnetic cooling device 30. The controller 700 may be electrically connected to various components of the magnetic cooling device 30. The controller 700 may control various components of the magnetic cooling device 30 (e.g., the driving device 500).

The controller 700 may include hardware such as CPU, microcontroller, memory, etc., and software such as control programs. For example, the controller 700 may include at least one memory 720 that stores data in the form of algorithms and programs for controlling the operation of the components of the magnetic cooling device 30. For example, the controller 700 may include at least one processor 710 including various processing circuitry that performs operations using data stored in the at least one memory 720. The memory 720 and processor 710 may each be implemented as separate chips. The processor 710 may include one or more processor chips or one or more processing cores. The memory 720 may include one or more memory chips or one or more memory blocks. Also, the memory 720 and processor 710 may be implemented as a single chip. Thus, the processor 710 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

The driving device 500 may include various circuitry and a motor and generate driving force and provide it to the magnet 200, first fluid transfer device 300, and/or second fluid transfer device 400. The driving device 500 may be configured to rotate the magnet 200, first chamber 311 of the first fluid transfer device 300, and/or second chamber 411 of the second fluid transfer device 400. The driving device 500 may be configured to rotate the magnet 200, first rotating frame 310 of the first fluid transfer device 300, and/or second rotating frame 410 of the second fluid transfer device 400.

The driving device 500 may include a motor 520 that generates rotational force. The driving device 500 may include a rotating shaft 510 configured to transmit rotational force to the magnet 200, first fluid transfer device 300, and second fluid transfer device 400.

The controller 700 may control the driving device 500. The controller 700 may control the driving device 500 based on the mode of the magnetic cooling device 30 (a first mode M1 and a second mode M2, which will be described in greater detail below). The controller 700 may control the driving device 500 so that the magnet 200, first chamber 311, and second chamber 411 rotate in synchronization. For example, the controller 700 may control the on/off, rotation speed, and rotation direction of the driving device 500.

According to an embodiment of the present disclosure, the driving device 500 may rotate the magnet 200, first chamber 311 of the first fluid transfer device 300, and second chamber 411 of the second fluid transfer device 400 together. In other words, the magnetic cooling device 30 according to an embodiment of the present disclosure may not include a plurality of driving devices to rotate the magnet 200, first chamber 311, and second chamber 411 respectively. Accordingly, additional power sources may not be required for operation of the magnetic cooling device 30, enabling energy savings. Also, rotation of the magnet 200, first chamber 311, and second chamber 411 may be synchronized more easily.

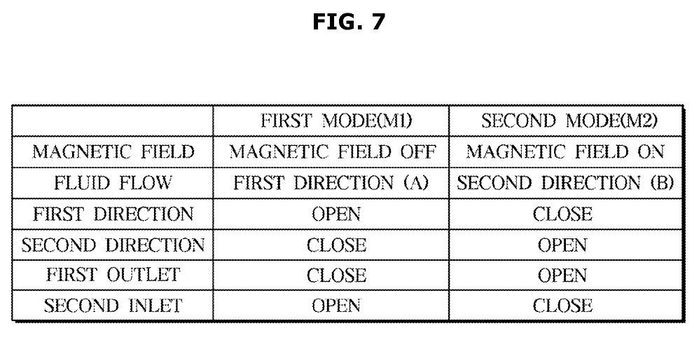

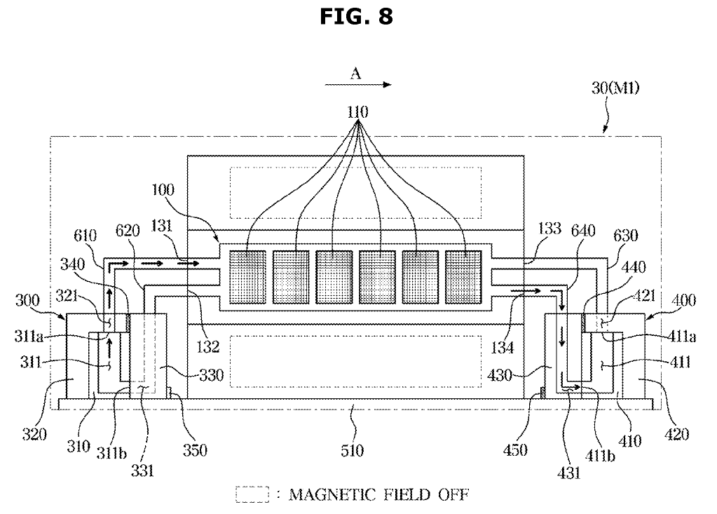

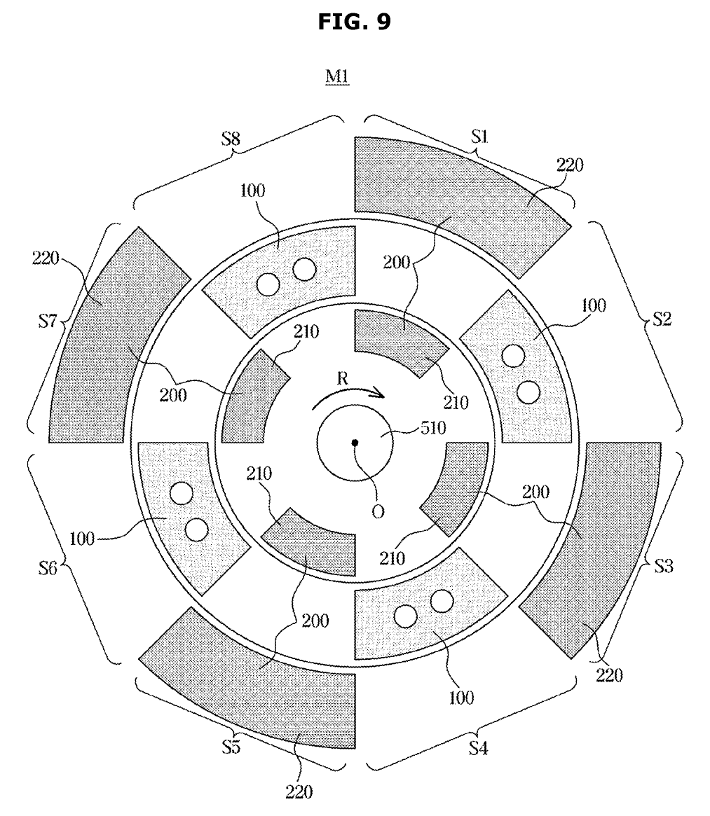

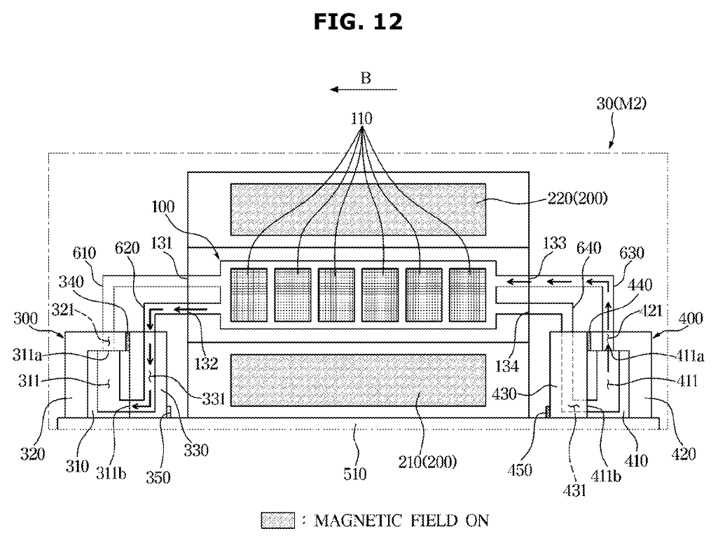

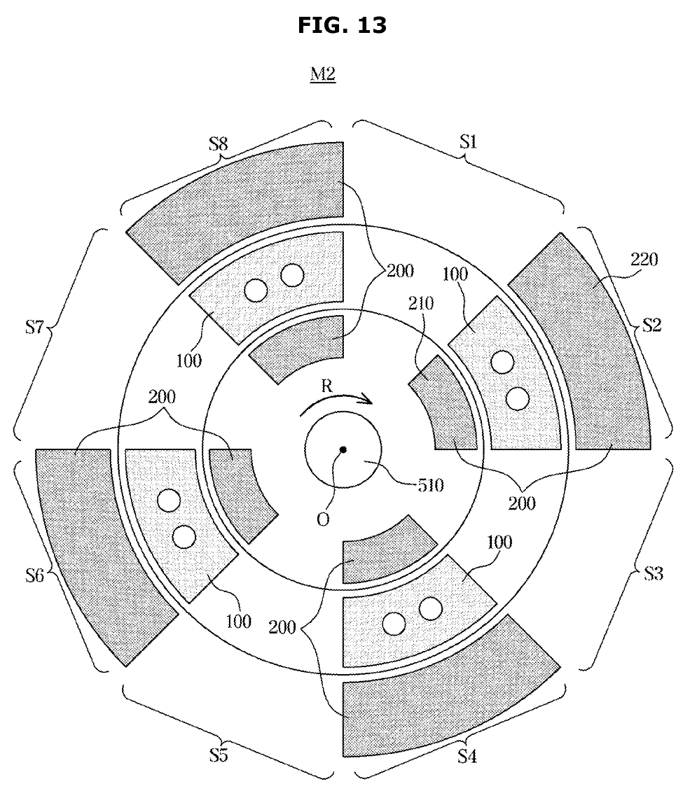

FIG. 7 is a table illustrating an example operation of a magnetic cooling device according to various embodiments. FIG. 8 is a diagram illustrating a state in which a magnetic cooling device operates in a first mode according to various embodiments. FIG. 9 is a diagram illustrating a magnetocaloric unit and magnet in a first mode of a magnetic cooling device according to various embodiments. FIG. 10 is a diagram illustrating a first fluid transfer device in a first mode of a magnetic cooling device according to various embodiments. FIG. 11 is a diagram illustrating a second fluid transfer device in a first mode of a magnetic cooling device according to various embodiments. FIG. 12 is a diagram illustrating a state in which a magnetic cooling device operates in a second mode according to various embodiments. FIG. 13 is a diagram illustrating a magnetocaloric unit and magnet in a second mode of a magnetic cooling device according to various embodiments. FIG. 14 is a diagram illustrating a first fluid transfer device in a second mode of a magnetic cooling device according to various embodiments. FIG. 15 is a diagram illustrating a second fluid transfer device in a second mode of a magnetic cooling device according to various embodiments.

A magnetic cooling device 30 according to an embodiment of the present disclosure may operate in a first mode M1 or a second mode M2. The magnetic cooling device 30 may be configured to be switchable between the first mode M1 and the second mode M2. The magnetic cooling device 30 may switch from the first mode M1 to the second mode M2, or from the second mode M2 to the first mode M1. The mode of the magnetic cooling device 30 may be changed periodically. The mode of the magnetic cooling device 30 may be changed periodically by rotation of the magnet 200, first chamber 311, and second chamber 411.

Referring to FIGS. 7 through 11, the magnetic cooling device 30 may operate in the first mode M1. When the magnetic cooling device 30 operates in the first mode M1, heat transfer fluid cooled by the magnetocaloric unit 100 may move in a first direction A. Based on the magnetic cooling device 30 operating in the first mode M1, the first fluid transfer device 300 may supply heat transfer fluid to the magnetocaloric unit 100. Based on the magnetic cooling device 30 operating in the first mode M1, the magnetocaloric unit 100 may cool the heat transfer fluid. Based on the magnetic cooling device 30 operating in the first mode M1, the second fluid transfer device 400 may receive heat transfer fluid from the magnetocaloric unit 100.

Referring to FIGS. 8 and 9, while the magnetic cooling device 30 operates in the first mode M1, the magnet 200 may not apply a magnetic field to the magnetocaloric material 110. For example, when the magnetic cooling device 30 is in the first mode M1, the magnetic field may be in an OFF state. The temperature of the heat transfer fluid passing through the magnetocaloric material 110 may decrease.

Referring to FIGS. 8 and 10, while the magnetic cooling device 30 operates in the first mode M1, the first chamber 311 may be connected to the first outlet 321. While the magnetic cooling device 30 operates in the first mode M1, the outer portion 311a of the first chamber 311 may communicate with the first outlet 321. For example, the first outlet 321 may be in an OPEN state. Due to centrifugal force generated as the first chamber 311 rotates, heat transfer fluid in the first chamber 311 may flow toward the first outlet 321 (see a dashed-dotted arrow in FIG. 10). The first outlet 321 may be arranged to guide heat transfer fluid discharged from the first chamber 311 toward the magnetocaloric unit 100. The first connection pipe 610 may be arranged to guide heat transfer fluid coming from the first outlet 321 to the first port 131.

Referring to FIGS. 8 and 10, while the magnetic cooling device 30 operates in the first mode M1, the first chamber 311 may not be connected to the first inlet 331. While the magnetic cooling device 30 operates in the first mode M1, the inner portion 311b of the first chamber 311 may not communicate with the first inlet 331. Heat transfer fluid may not flow between the inner portion 311b of the first chamber 311 and the first inlet 331. For example, the first inlet 331 may be in a CLOSED state.

Referring to FIGS. 8 and 11, while the magnetic cooling device 30 operates in the first mode M1, the second chamber 411 may not be connected to the second outlet 421. While the magnetic cooling device 30 operates in the first mode M1, the outer portion 411a of the second chamber 411 may not communicate with the second outlet 421. Heat transfer fluid may not flow between the outer portion 411a of the second chamber 411 and the second outlet 421. For example, the second outlet 421 may be in a CLOSED state.

Referring to FIGS. 8 and 11, while the magnetic cooling device 30 operates in the first mode M1, the second chamber 411 may be connected to the second inlet 431. While the magnetic cooling device 30 operates in the first mode M1, the inner portion 411b of the second chamber 411 may communicate with the second inlet 431. For example, the second inlet 431 may be in an OPEN state. In a state where the second chamber 411 and the second inlet 431 communicate, heat transfer fluid flowing out of the magnetocaloric unit 100 may flow toward the second chamber 411 through the second inlet 431 (see a dashed arrow in FIG. 11). The second inlet 431 may be arranged to guide heat transfer fluid discharged from the magnetocaloric unit 100 toward the second chamber 411. The fourth connection pipe 640 may be arranged to guide heat transfer fluid coming from the fourth port 134 to the second inlet 431.

According to an embodiment of the present disclosure, while the magnetic cooling device 30 operates in the first mode M1, heat transfer fluid flowing out of the first chamber 311 through the first outlet 321 may pass through the magnetocaloric unit 100 and flow into the second chamber 411 through the second inlet 431. For example, while the magnetic cooling device 30 operates in the first mode M1, heat transfer fluid in the first chamber 311 may pass through the first outlet 321, first connection pipe 610, first port 131, magnetocaloric material 110, fourth port 134, fourth connection pipe 640, and second inlet 431, and then flow into the second chamber 411.

Referring to FIGS. 7 and 12 through 15, the magnetic cooling device 30 may operate in the second mode M2. When the magnetic cooling device 30 operates in the second mode M2, heat transfer fluid heated by the magnetocaloric unit 100 may move in a second direction B opposite to the first direction A. Based on the magnetic cooling device 30 operating in the second mode M2, the second fluid transfer device 400 may supply heat transfer fluid to the magnetocaloric unit 100. Based on the magnetic cooling device 30 operating in the second mode M2, the magnetocaloric unit 100 may heat the heat transfer fluid. Based on the magnetic cooling device 30 operating in the second mode M2, the first fluid transfer device 300 may receive heat transfer fluid from the magnetocaloric unit 100.

Referring to FIGS. 12 and 13, while the magnetic cooling device 30 operates in the second mode M2, the magnet 200 may apply a magnetic field to the magnetocaloric material 110. For example, when the magnetic cooling device 30 is in the second mode M2, the magnetic field may be in an ON state. At this time, the temperature of the heat transfer fluid passing through the magnetocaloric material 110 may increase.

Referring to FIGS. 12 and 14, while the magnetic cooling device 30 operates in the second mode M2, the first chamber 311 may not be connected to the first outlet 321. While the magnetic cooling device 30 operates in the second mode M2, the outer portion 311a of the first chamber 311 may not communicate with the first outlet 321. Heat transfer fluid may not flow between the outer portion 311a of the first chamber 311 and the first outlet 321. For example, the first outlet 321 may be in a CLOSED state.

Referring to FIGS. 12 and 14, while the magnetic cooling device 30 operates in the second mode M2, the first chamber 311 may be connected to the first inlet 331. While the magnetic cooling device 30 operates in the second mode M2, the inner portion 311b of the first chamber 311 may communicate with the first inlet 331. For example, the first inlet 331 may be in an OPEN state. In a state where the first chamber 311 and the first inlet 331 communicate, heat transfer fluid flowing out of the magnetocaloric unit 100 may flow toward the first chamber 311 through the first inlet 331 (see a dashed arrow in FIG. 14). The first inlet 331 may be arranged to guide heat transfer fluid discharged from the magnetocaloric unit 100 toward the first chamber 311. The second connection pipe 620 may be arranged to guide heat transfer fluid coming from the second port 132 to the first inlet 331.

Referring to FIGS. 12 and 15, while the magnetic cooling device 30 operates in the second mode M2, the second chamber 411 may be connected to the second outlet 421. While the magnetic cooling device 30 operates in the second mode M2, the outer portion 411a of the second chamber 411 may communicate with the second outlet 421. That is, the second outlet 421 may be in an OPEN state. Due to centrifugal force generated as the second chamber 411 rotates, heat transfer fluid in the second chamber 411 may flow toward the second outlet 421 (see a dashed-dotted arrow in FIG. 15). The second outlet 421 may be arranged to guide heat transfer fluid discharged from the second chamber 411 toward the magnetocaloric unit 100. The third connection pipe 630 may be arranged to guide heat transfer fluid coming from the second outlet 421 to the third port 133.

Referring to FIGS. 12 and 15, while the magnetic cooling device 30 operates in the second mode M2, the second chamber 411 may not be connected to the second inlet 431. While the magnetic cooling device 30 operates in the second mode M2, the inner portion 411b of the second chamber 411 may not communicate with the second inlet 431. Heat transfer fluid may not flow between the inner portion 411b of the second chamber 411 and the second inlet 431. That is, the second inlet 431 may be in a CLOSED state.

According to an embodiment of the present disclosure, while the magnetic cooling device 30 operates in the second mode M2, heat transfer fluid flowing out of the second chamber 411 through the second outlet 421 may pass through the magnetocaloric unit 100 and flow into the first chamber 311 through the first inlet 331. For example, while the magnetic cooling device 30 operates in the second mode M2, heat transfer fluid in the second chamber 411 may pass through the second outlet 421, third connection pipe 630, third port 133, magnetocaloric material 110, second port 132, second connection pipe 620, and first inlet 331, and then flow into the first chamber 311.

According to an embodiment of the present disclosure, the first chamber 311 may be configured to communicate with either one of the first outlet 321 and the first inlet 331 as it rotates (see FIGS. 10 and 14). That is, when the first outlet 321 is opened, the first inlet 331 is closed, and conversely, when the first outlet 321 is closed, the first inlet 331 is opened. Accordingly, the open/closed states of the first outlet 321 and the first inlet 331 may be synchronized in opposite manner, and mode switching of the magnetic cooling device 30 may be performed quickly. Also, when the magnetic cooling device 30 is in the first mode M1, the first fluid transfer device 300 may supply a more uniform amount of heat transfer fluid to the magnetocaloric unit 100.

According to an embodiment of the present disclosure, the outer portion 311a of the first chamber 311 and the inner portion 311b of the first chamber 311 may be configured to have the same angular range with respect to the rotation center O (see FIGS. 10 and 14). For example, the outer portion 311a of the first chamber 311 and the inner portion 311b of the first chamber 311 may be configured to have the same central angle C1. For example, the outer portion 311a of the first chamber 311 may be disposed radially outward from the inner portion 311b of the first chamber 311, and the length along the circumferential direction of the outer portion 311a of the first chamber 311 may be longer than the length along the circumferential direction of the inner portion 311b of the first chamber 311. Thus, the flow rate of heat transfer fluid supplied to the magnetocaloric unit 100 when the magnetic cooling device 30 operates in the first mode M1 may be increased.

According to an embodiment of the present disclosure, the second chamber 411 may be configured to communicate with either one of the second outlet 421 and the second inlet 431 as it rotates (see FIGS. 11 and 15). That is, when the second outlet 421 is opened, the second inlet 431 is closed, and conversely, when the second outlet 421 is closed, the second inlet 431 is opened. Accordingly, the open/closed states of the second outlet 421 and the second inlet 431 may be synchronized in opposite manner, and mode switching of the magnetic cooling device 30 may be performed quickly. Also, when the magnetic cooling device 30 is in the second mode M2, the second fluid transfer device 400 may supply a more uniform amount of heat transfer fluid to the magnetocaloric unit 100.

According to an embodiment of the present disclosure, the outer portion 411a of the second chamber 411 and the inner portion 411b of the second chamber 411 may be configured to have the same angular range with respect to the rotation center O (see FIGS. 11 and 15). For example, the outer portion 411a of the second chamber 411 and the inner portion 411b of the second chamber 411 may be configured to have the same central angle C2. For example, the outer portion 411a of the second chamber 411 may be disposed radially outward from the inner portion 411b of the second chamber 411, and the length along the circumferential direction of the outer portion 411a of the second chamber 411 may be longer than the length along the circumferential direction of the inner portion 411b of the second chamber 411. Thus, the flow rate of heat transfer fluid supplied to the magnetocaloric unit 100 when the magnetic cooling device 30 operates in the second mode M2 may be increased.

According to an embodiment of the present disclosure, the first chamber 311 of the first fluid transfer device 300 and the magnet 200 may not be arranged to correspond along the longitudinal direction L of the rotating shaft 510. The first chamber 311 of the first fluid transfer device 300 and the magnet 200 may be arranged in a staggered manner. For example, it is assumed that the magnet 200 and first chamber 311 are each provided in four units and there is an arrangement area equally divided into 8 sections based on 360 degrees. While the magnet 200 is disposed in odd-numbered sections (first section S1: 0~45 degrees, third section S3: 90~135 degrees, fifth section S5: 180~225 degrees, seventh section S7: 270~315 degrees), the first chamber 311 may be arranged to correspond to even-numbered sections (second section S2: 45~90 degrees, fourth section S4: 135~180 degrees, sixth section S6: 225~270 degrees, eighth section S8: 315~360 degrees). Conversely, while the magnet 200 is disposed in even-numbered sections, the first chamber 311 may be arranged to correspond to odd-numbered sections.

According to an embodiment of the present disclosure, the second chamber 411 of the second fluid transfer device 400 and the magnet 200 may not be arranged to correspond along the longitudinal direction L of the rotating shaft 510. The second chamber 411 of the second fluid transfer device 400 and the magnet 200 may be arranged to be aligned. For example, it is assumed that the magnet 200 and second chamber 411 are each provided in four units and there is an arrangement area equally divided into 8 sections based on 360 degrees. While the magnet 200 is disposed in odd-numbered sections, the second chamber 411 may be arranged to correspond to odd-numbered sections. While the magnet 200 is disposed in even-numbered sections, the second chamber 411 may be arranged to correspond to even-numbered sections.

In general, magnetic cooling devices include pumps and valves for movement of heat transfer fluid. However, pressure control of pumps and on/off control of valves may be quite complex, and heat transfer fluid may not be uniformly supplied to a plurality of magnetocaloric units due to signal delays occurring during the control process. Also, noise may be generated due to pump operation, and the overall structure may become complex as valves need to be installed at ports of a plurality of magnetocaloric units.

According to the present disclosure, the magnetic cooling device 30 may not include separate pumps and valves. The magnetic cooling device 30 may transfer heat transfer fluid simply using a structure utilizing centrifugal force. The magnetic cooling device 30 may uniformly supply heat transfer fluid to a plurality of magnetocaloric units by synchronizing rotation of the magnet 200, first chamber 311 of the first fluid transfer device 300, and second chamber 411 of the second fluid transfer device 400. Since the magnetic cooling device 30 does not require pumps, noise may be reduced. Since the magnetic cooling device 30 does not require valves, the overall structure may be simplified compared to conventional systems.

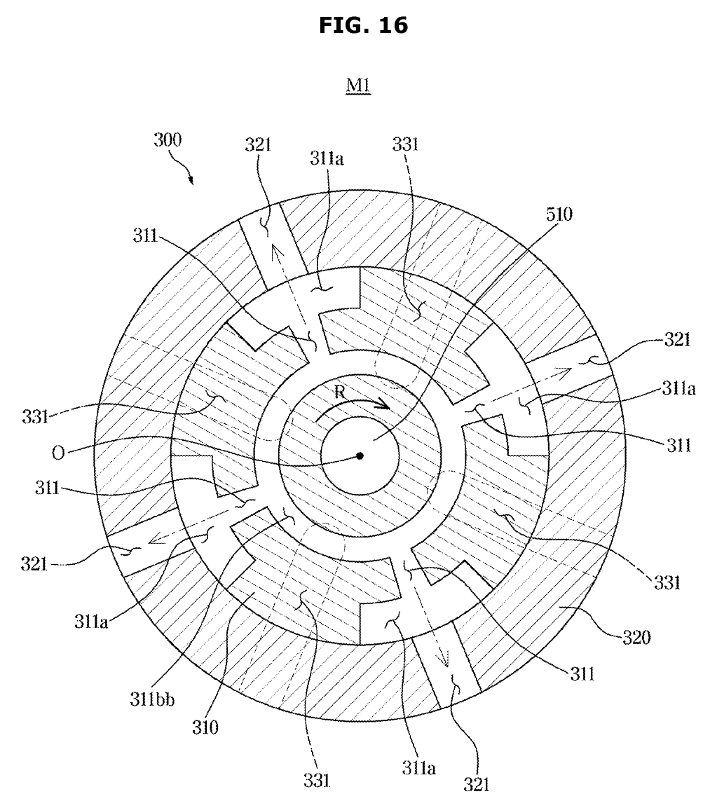

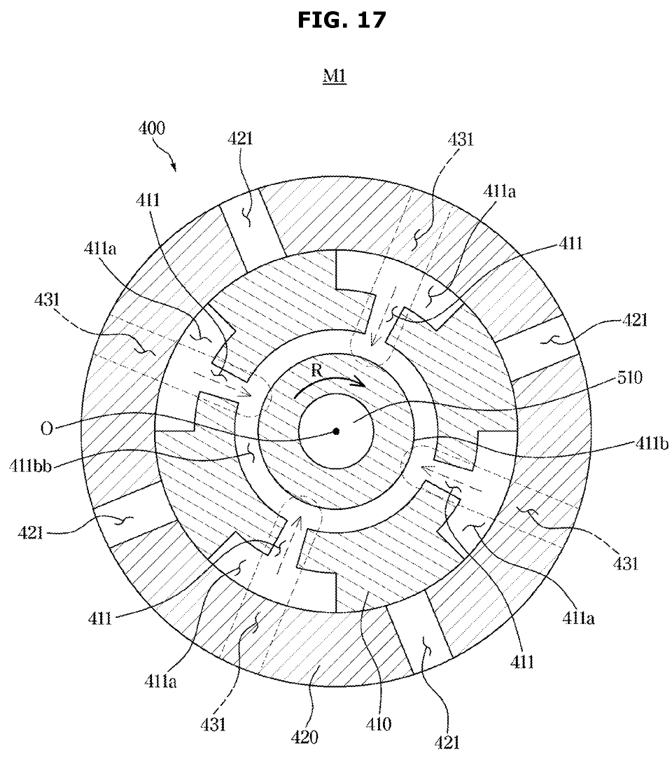

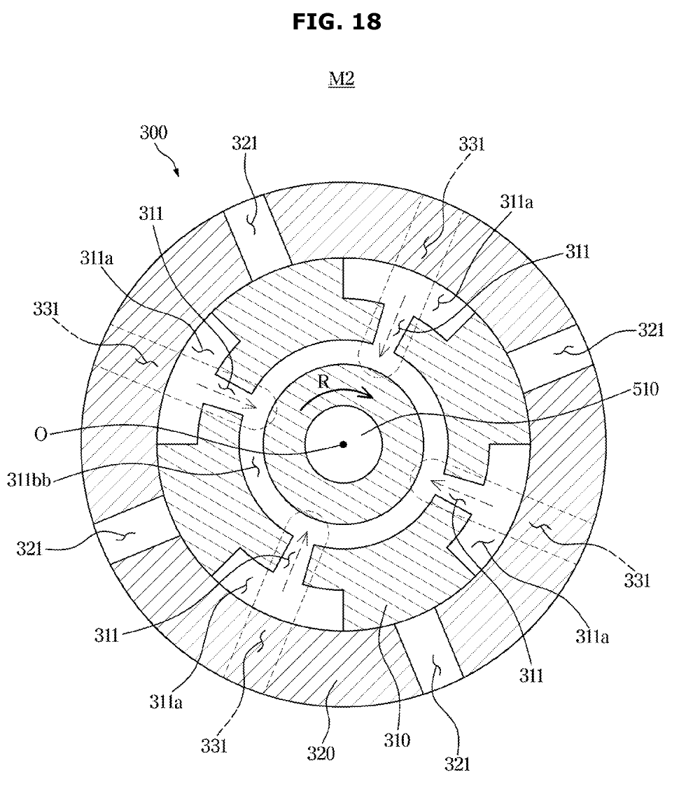

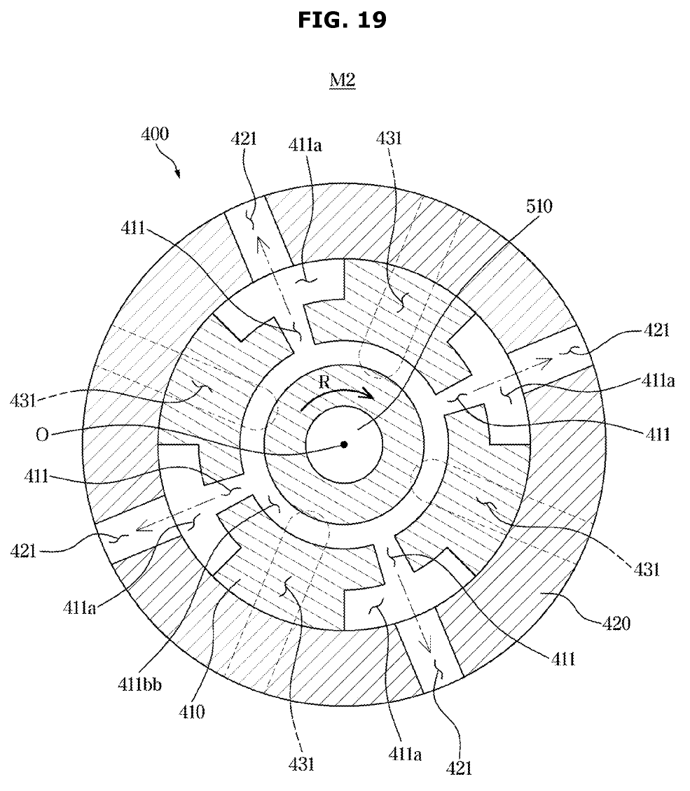

FIG. 16 is a diagram illustrating a first fluid transfer device in a first mode of a magnetic cooling device according to various embodiments. FIG. 17 is a diagram illustrating a second fluid transfer device in a first mode of a magnetic cooling device according to various embodiments. FIG. 18 is a diagram illustrating a first fluid transfer device in a second mode of a magnetic cooling device according to various embodiments. FIG. 19 is a diagram illustrating a second fluid transfer device in a second mode of a magnetic cooling device according to various embodiments.

Compared to the first fluid transfer device 300 shown in FIGS. 10 and 14, the first fluid transfer device 300 shown in FIGS. 16 and 18 may be substantially identical except for the shape of the inner portion of the first chamber 311. Components substantially identical to those described above are given the same reference numerals, and redundant descriptions may not be repeated here.

According to an embodiment of the present disclosure, the first chamber 311 may be configured to selectively communicate with the first outlet 321. According to an embodiment of the present disclosure, the first chamber 311 may be configured to always communicate with the first inlet 331.

For example, the inner portion 311bb of the first chamber 311 may extend along the circumferential direction. The inner portion 311b of the first chamber 311 may extend along the rotation direction. The inner portion 311b of the first chamber 311 may have an approximately ring shape. Thus, the inner portion 311bb of the first chamber 311 may always be connected to the first inlet 331. When the first fluid transfer device 300 includes a plurality of first inlets 331, the inner portion 311bb of the first chamber 311 may communicate with all of the plurality of first inlets 331.

As described above, when the magnetic cooling device 30 operates in the first mode M1, the first fluid transfer device 300 may supply heat transfer fluid to the magnetocaloric unit 100 using centrifugal force. For example, heat transfer fluid in the first chamber 311 may receive force toward the radially outward direction by centrifugal force. Most of the heat transfer fluid in the first chamber 311 may flow toward the first outlet 321 by centrifugal force and hardly flow toward the first inlet 331. Even when the inner portion 311bb of the first chamber 311 maintains communication with the first inlet 331, it may not significantly affect the direction of heat transfer fluid movement. Accordingly, for example, the first chamber 311 may have a shape that always communicates with the first inlet 331. With such a shape of the first chamber 311, fluid flow resistance may be reduced and the structure of the first chamber 311 may be further simplified.

Compared to the second fluid transfer device 400 shown in FIGS. 11 and 15, the second fluid transfer device 400 shown in FIGS. 17 and 19 may be substantially identical except for the shape of the inner portion of the second chamber 411. Components substantially identical to those described above are given the same reference numerals, and redundant descriptions may may not be repeated here.

According to an embodiment of the present disclosure, the second chamber 411 may be configured to selectively communicate with the second outlet 421. According to an embodiment of the present disclosure, the second chamber 411 may be configured to always communicate with the second inlet 431.

For example, the inner portion 411bb of the second chamber 411 may extend along the circumferential direction. The inner portion 411b of the second chamber 411 may extend along the rotation direction. The inner portion 411b of the second chamber 411 may have an approximately ring shape. Thus, the inner portion 411bb of the second chamber 411 may always be connected to the second inlet 431. Also, when the second fluid transfer device 400 includes a plurality of second inlets 431, the inner portion 411bb of the second chamber 411 may communicate with all of the plurality of second inlets 431.

As described above, when the magnetic cooling device 30 operates in the second mode M2, the second fluid transfer device 400 may supply heat transfer fluid to the magnetocaloric unit 100 using centrifugal force. For example, heat transfer fluid in the second chamber 411 may receive force toward the radially outward direction by centrifugal force. Most of the heat transfer fluid in the second chamber 411 may flow toward the second outlet 421 by centrifugal force and hardly flow toward the second inlet 431. Even when the inner portion 411bb of the second chamber 411 maintains communication with the second inlet 431, it may not significantly affect the direction of heat transfer fluid movement. Accordingly, for example, the second chamber 411 may have a shape that always communicates with the second inlet 431. With such a shape of the second chamber 411, fluid flow resistance may be reduced and the structure of the second chamber 411 may be further simplified.

As described above, the magnetic cooling device 30 according to an embodiment of the present disclosure may operate in the first mode M1 or second mode M2. When the magnetic cooling device 30 operates in the first mode M1, heat transfer fluid cooled by the magnetocaloric unit 100 may move in the first direction A. While the magnetic cooling device 30 operates in the first mode M1, the magnet 200 may not apply a magnetic field to the magnetocaloric material 110. When the magnetic cooling device 30 operates in the second mode M2, heat transfer fluid heated by the magnetocaloric unit 100 may move in the second direction B. While the magnetic cooling device 30 operates in the second mode M2, the magnet 200 may apply a magnetic field to the magnetocaloric material 110.

Referring to FIG. 16, while the magnetic cooling device 30 operates in the first mode M1, the first chamber 311 may communicate with the first outlet 321 and the first inlet 331. Due to centrifugal force generated as the first chamber 311 rotates, heat transfer fluid in the first chamber 311 may flow toward the first outlet 321 (see a dashed-dotted arrow in FIG. 16).

Referring to FIG. 17, while the magnetic cooling device 30 operates in the first mode M1, the second chamber 411 may not communicate with the second outlet 421 and may communicate with the second inlet 431. Heat transfer fluid flowing out of the magnetocaloric unit 100 may flow toward the second chamber 411 through the second inlet 431 (see a dashed arrow in FIG. 17).

Referring to FIG. 18, while the magnetic cooling device 30 operates in the second mode M2, the first chamber 311 may not communicate with the first outlet 321 and may communicate with the first inlet 331. Heat transfer fluid flowing out of the magnetocaloric unit 100 may flow toward the first chamber 311 through the first inlet 331 (see a dashed arrow in FIG. 18).

Referring to FIG. 19, while the magnetic cooling device 30 operates in the second mode M2, the second chamber 411 may communicate with the second outlet 421 and the second inlet 431. Due to centrifugal force generated as the second chamber 411 rotates, heat transfer fluid in the second chamber 411 may flow toward the second outlet 421 (see a dashed-dotted arrow in FIG. 19).

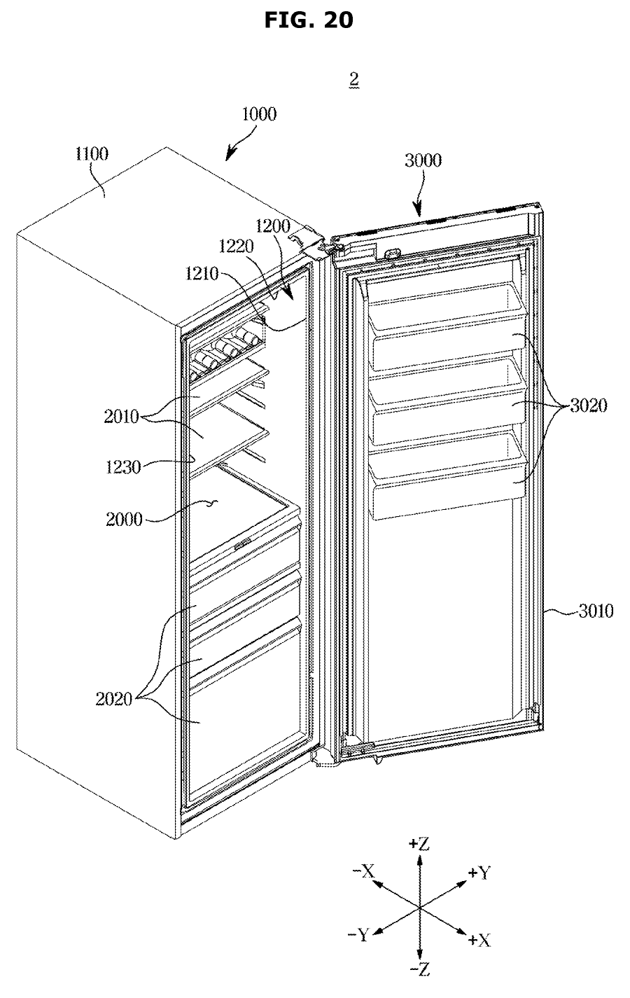

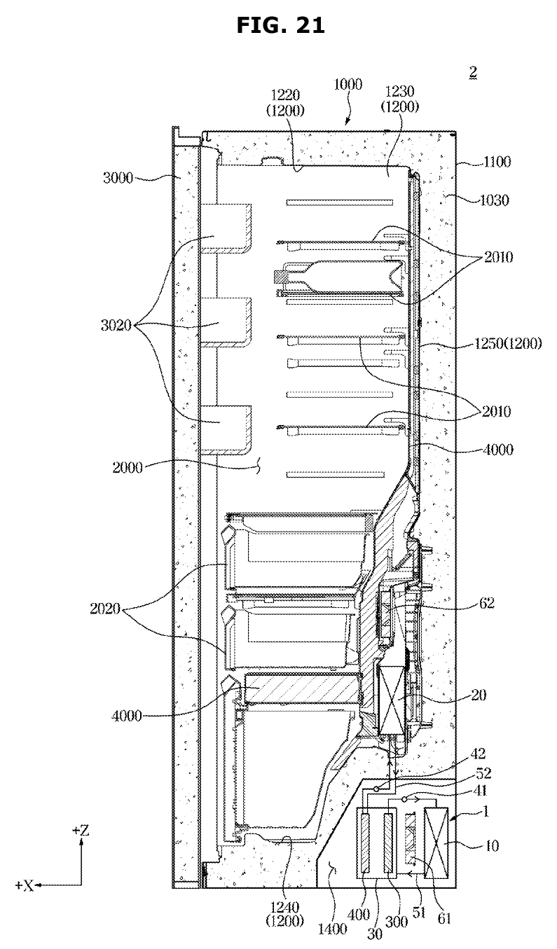

FIG. 20 is a perspective view of a refrigerator including a cooling cycle apparatus according to various embodiments. FIG. 21 is a side sectional view of a refrigerator including a cooling cycle apparatus according to various embodiments. Components substantially identical to those described above are given the same reference numbers, and redundant descriptions may not be repeated here.

FIGS. 20 and 21 show a refrigerator 2 as an example of a household appliance including the cooling cycle apparatus 1.

Referring to FIGS. 20 and 21, the refrigerator 2 may include a main body 1000. The refrigerator 2 may include a storage compartment 2000 provided inside the main body 1000. The refrigerator 2 may include a door 3000 arranged to open and close the storage compartment 2000. The refrigerator 2 may include a cooling cycle apparatus (a cooling system) 1 for supplying cool air to the storage compartment 2000.

The main body 1000 may form at least part of the exterior of the refrigerator 2. The main body 1000 may be formed with an open front so that users may store and retrieve food from the storage compartment 2000. The main body 1000 may include an opening. The opening of the main body 1000 may be opened and closed by the door 3000.

The door 3000 may be arranged to open and close the main body 1000. The door 3000 may be arranged to open and close the opening of the main body 1000. The door 3000 may be rotatably coupled to the main body 1000. For example, the door 3000 may be rotatably coupled to the main body 1000 by hinges connected to the door 3000 and the main body 1000, respectively.

The door 3000 may include a door gasket 3010. The door gasket 3010 may seal the gap between the door 3000 and the main body 1000 to prevent/reduce cool air from the storage compartment 2000 from leaking.

The door 3000 may include a door basket 3020. The door basket 3020 may be arranged to store/preserve food.

The main body 1000 may include an outer case 1100. The outer case 1100 may form at least part of the exterior of the refrigerator 2. The outer case 1100 may be provided outside the inner case 1200. The outer case 1100 may be formed to have a box shape with an approximately open front. For example, the outer case 1100 may form the top, bottom, left, right, and rear surfaces of the refrigerator 2.

The main body 1000 may include an inner case 1200. The inner case 1200 may be provided inside the outer case 1100. The inner case 1200 may form the storage compartment 2000. The internal space of the inner case 1200 may be referred to as the storage compartment 2000. The inner case 1200 may have an open front shape. The inner case 1200 may be formed to have a box shape with an approximately open front.

The inner case 1200 may include inner walls 1210, 1220, 1230, 1240, 1250. For example, the inner case 1200 may include a right wall 1210, top wall 1220, left wall 1230, bottom wall 1240, and rear wall 1250. For example, the right wall 1210, top wall 1220, left wall 1230, bottom wall 1240, and rear wall 1250 of the inner case 1200 may form the storage compartment 2000.

The main body 1000 may include main body insulation 1030. The main body insulation 1030 may be provided between the outer case 1100 and the inner case 1200. The main body insulation 1030 may be arranged so that the outer case 1100 and inner case 1200 are thermally insulated from each other. The main body insulation 1030 may couple the outer case 1100 and inner case 1200 to each other by being foamed between the outer case 1100 and inner case 1200. The main body insulation 1030 may prevent/reduce heat exchange between the interior of the storage compartment 2000 and the exterior of the main body 1000, thereby improving the cooling efficiency inside the storage compartment 2000.

The main body 1000 may include a storage compartment 2000. The storage compartment 2000 may be formed by the inner case 1200. For example, the inner case 1200 may have a box shape with an approximately open front, and the storage compartment 2000 may be formed therein. The storage compartment 2000 may be divided into a plurality of sections by a partition 5000. For example, the storage compartment 2000 may be divided into a refrigerating compartment and a freezing compartment by the partition 5000.

For example, the storage compartment 2000 may be provided with shelves 2010 on which food may be placed and storage containers (not shown) in which food may be stored. For example, the storage compartment 2000 may be provided with drawers 2020 that may be withdrawn from and inserted into the storage compartment 2000 through the opening of the main body 1000.

The refrigerator 2 may include a duct 4000. The duct 4000 may be arranged to allow cool air to flow. The duct 4000 may form a flow path through which cool air flows. The duct 4000 may be arranged to guide cool air. The duct 4000 may be configured to collect air inside the storage compartment 2000 and supply air (e.g., cool air) that has been collected and heat-exchanged to the storage compartment 2000. The duct 4000 may be disposed inside the inner case 1200.

The refrigerator 2 may include a cooling cycle apparatus 1 arranged to generate cool air using a cooling cycle and supply the generated cool air to the storage compartment 2000. The cooling cycle apparatus 1 may include a first heat exchanger 10, second heat exchanger 20, and magnetic cooling device 30.

For example, the first heat exchanger 10 and magnetic cooling device 30 may be disposed outside the inner case 1200, and the second heat exchanger 20 may be disposed inside the inner case 1200. For example, the first heat exchanger 10 and magnetic cooling device 30 may be disposed in a machine room, and the second heat exchanger 20 may be disposed in the storage compartment 2000.

For example, the refrigerator 2 may include a first fan 61. The first fan 61 may increase the heat exchange efficiency between the first fluid transfer device 300 and the first heat exchanger 10. The first fan 61 may be disposed in the machine room.

For example, the refrigerator 2 may include a second fan 62. The second fan 62 may forcibly flow cool air generated by the second heat exchanger 20 to the storage compartment 2000. The second fan 62 may be disposed inside the inner case 1200.

A magnetic cooling device 30 according to an example embodiment of the present disclosure may include: a magnet 200 arranged to form a magnetic field; a magnetocaloric unit 100 including magnetocaloric material 110 configured to change temperature by the magnetic field and arranged to allow heat transfer fluid to flow; a first fluid transfer device 300 connected to a hot side of the magnetocaloric unit and configured to transfer heat transfer fluid using centrifugal force; and a second fluid transfer device 400 connected to a cold side of the magnetocaloric unit and configured to transfer heat transfer fluid using centrifugal force. The first fluid transfer device 300 may include: a first chamber 311 configured to be rotatable relative to the magnetocaloric unit; a first outlet 321 configured to be connectable to an outer portion 311a of the first chamber; and a first inlet 331 configured to be connectable to an inner portion 311b of the first chamber. The second fluid transfer device 400 may include: a second chamber 411 configured to be rotatable relative to the magnetocaloric unit; a second outlet 421 configured to be connectable to an outer portion 411a of the second chamber; and a second inlet 431 configured to be connectable to an inner portion 411b of the second chamber.

The magnet 200 may be configured to be rotatable relative to the magnetocaloric unit 100. The rotation of the magnet 200, first chamber 311, and second chamber 411 may be configured to be synchronized.

The magnetic cooling device 30 may further include a rotating shaft 510 configured to rotate the magnet 200, first chamber 311, and second chamber 411 together.

The magnetic cooling device 30 may be configured to be switchable between a first mode M1 for moving heat transfer fluid cooled by the magnetocaloric unit in a first direction A, and a second mode M2 for moving heat transfer fluid heated by the magnetocaloric unit in a second direction B opposite to the first direction.

While the magnetic cooling device 30 operates in the first mode M1, the magnet 200 does not apply a magnetic field to the magnetocaloric material 110, the outer portion 311a of the first chamber 311 communicates with the first outlet 321, and the inner portion 411b of the second chamber 411 communicates with the second inlet 431.

While the magnetic cooling device 30 operates in the first mode M1, the first outlet 321 is arranged to guide heat transfer fluid discharged from the first chamber 311 toward the magnetocaloric unit 100, and the second inlet 431 is arranged to guide heat transfer fluid discharged from the magnetocaloric unit 100 toward the second chamber 411.

While the magnetic cooling device 30 operates in the second mode M2, the magnet 200 applies a magnetic field to the magnetocaloric material 110, the outer portion 411a of the second chamber 411 communicates with the second outlet 421, and the inner portion 311b of the first chamber 311 communicates with the first inlet 331.

While the magnetic cooling device 30 operates in the second mode M2, the second outlet 421 is arranged to guide heat transfer fluid discharged from the second chamber 411 toward the magnetocaloric unit 100, and the first inlet 331 is arranged to guide heat transfer fluid discharged from the magnetocaloric unit 100 toward the first chamber 311.

The first chamber 311 may be configured to communicate with either one of the first outlet 321 and the first inlet 331 as it rotates. The second chamber 411 may be configured to communicate with either one of the second outlet 421 and the second inlet 431 as it rotates.

The outer portion 311a of the first chamber 311 and the inner portion 311b of the first chamber 311 may be spaced apart along a radial direction and configured to have the same angular range with respect to a rotation center. The outer portion 411a of the second chamber 411 and the inner portion 411b of the second chamber 411 may be spaced apart along the radial direction and configured to have the same angular range with respect to a rotation center.

The first chamber 311 may be configured to selectively communicate with the first outlet 321 and always communicate with the first inlet 331. The second chamber 411 may be configured to selectively communicate with the second outlet 421 and always communicate with the second inlet 431.

The first inlet 331 may include a plurality of first inlets arranged spaced apart along a circumferential direction. The inner portion 311bb of the first chamber 311 may extend along the circumferential direction to communicate with all of the plurality of first inlets 331. The second inlet 431 may include a plurality of second inlets arranged spaced apart along the circumferential direction. The inner portion 411bb of the second chamber 411 may extend along the circumferential direction to communicate with all of the plurality of second inlets 431.

The first fluid transfer device 300 may include: a first rotating frame 310 coupled to the rotating shaft 510 and configured to be rotated by the rotating shaft 510, the first rotating frame 310 including the first chamber 311; a first fixed frame 320 accommodating the first rotating frame 310 and including the first outlet 321; and a second fixed frame 330 covering the first rotating frame 310 accommodated in the first fixed frame 320 and including the first inlet 331. The second fluid transfer device 400 may include: a second rotating frame 410 coupled to the rotating shaft 510 and configured to be rotated by the rotating shaft 510, the second rotating frame 410 including the second chamber 411; a third fixed frame 420 accommodating the second rotating frame 410 and including the second outlet 421; and a fourth fixed frame 430 covering the second rotating frame 410 accommodated in the third fixed frame 420 and including the second inlet 431.

The magnetic cooling device 30 may include: a first sealing member 340 disposed between the first fixed frame 320 and the second fixed frame 330; and a second sealing member 440 disposed between the third fixed frame 420 and the fourth fixed frame 430.

The first fluid transfer device 300, the magnet 200, and the second fluid transfer device 400 may be arranged along a longitudinal direction L of the rotating shaft 510. The first chamber 311 and the magnet 200 may not be arranged to correspond along the longitudinal direction of the rotating shaft 510. The second chamber 411 and the magnet 200 may be arranged to correspond along the longitudinal direction of the rotating shaft 510.

A cooling cycle apparatus 1 according to an example embodiment of the present disclosure may include: a first heat exchanger 10 arranged to discharge heat; a second heat exchanger 20 arranged to absorb heat; and a magnetic cooling device 30 disposed between the first heat exchanger 10 and the second heat exchanger 20 and arranged to operate in a first mode M1 or a second mode M2. The magnetic cooling device 30 may include: a magnetocaloric unit 100 including a case and magnetocaloric material disposed inside the case and having temperature that changes based on a magnetic field; a magnet 200 that generates the magnetic field; a first fluid transfer device 300 connected to a hot side of the magnetocaloric unit and configured to transfer heat transfer fluid using centrifugal force; a second fluid transfer device 400 connected to a cold side of the magnetocaloric unit and configured to transfer heat transfer fluid using centrifugal force; and a rotating shaft 510 configured to transmit rotational force to the magnet 200, the first fluid transfer device 300, and the second fluid transfer device 400.

The first fluid transfer device 300 may be arranged to perform heat exchange with the first heat exchanger 10. The second fluid transfer device 400 may be arranged to perform heat exchange with the second heat exchanger 20.

The first fluid transfer device 300 may include: a first chamber 311 configured to be rotatable by the rotating shaft 510; a first outlet 321 configured to be connectable to an outer portion 311a of the first chamber; and a first inlet 331 configured to be connectable to an inner portion 311b of the first chamber. The second fluid transfer device 400 may include: a second chamber 411 configured to be rotatable by the rotating shaft 510; a second outlet 421 configured to be connectable to an outer portion 411a of the second chamber; and a second inlet 431 configured to be connectable to an inner portion 411b of the second chamber.

While the magnetic cooling device 30 operates in the first mode M1, the magnet 200 does not apply a magnetic field to the magnetocaloric material, the outer portion 311a of the first chamber communicates with the first outlet 321, and the inner portion 411b of the second chamber communicates with the second inlet 431. While the magnetic cooling device 30 operates in the second mode M2, the magnet 200 applies a magnetic field to the magnetocaloric material, the outer portion 411a of the second chamber communicates with the second outlet 421, and the inner portion 311b of the first chamber communicates with the first inlet 331.

While the magnetic cooling device 30 operates in the first mode M1, heat transfer fluid flowing out from the first chamber 311 through the first outlet 321 may pass through the magnetocaloric unit 100 and flow into the second chamber 411 through the second inlet 431. While the magnetic cooling device 30 operates in the second mode M2, heat transfer fluid flowing out from the second chamber 411 through the second outlet 421 may pass through the magnetocaloric unit 100 and flow into the first chamber 311 through the first inlet 331.

According to various example embodiments of the present disclosure, the magnetic cooling device 30 may move heat transfer fluid using centrifugal force of the first fluid transfer device 300 and centrifugal force of the second fluid transfer device 400. The rotation of the magnet 200 of the magnetic cooling device 30, the first chamber 311 of the first fluid transfer device 300, and the second chamber 411 of the second fluid transfer device 400 may be synchronized. Thus, heat transfer fluid may be uniformly distributed to a plurality of magnetocaloric units 100, and the performance of the magnetic cooling device 30 may be improved.

According to various example embodiments of the present disclosure, the magnetic cooling device 30 may have a simple structure. The magnetic cooling device 30 may not include separate pumps or separate valves. Thus, noise due to pumps and/or valves does not occur, and there is no need to perform pressure adjustment of pumps or on/off control of valves. The convenience of use of the magnetic cooling device 30 may be increased.

The effects obtainable from the present disclosure are not limited to the effects mentioned above, and other effects not mentioned will be clearly understood by those skilled in the art from the present disclosure.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A magnetic cooling device comprising:
a magnet configured to form a magnetic field;
a magnetocaloric unit including a magnetocaloric material configured to change temperature by the magnetic field and configured to allow a heat transfer fluid to flow therethrough;
a first fluid transfer device connected to a hot side of the magnetocaloric unit and configured to transfer the heat transfer fluid using centrifugal force; and
a second fluid transfer device connected to a cold side of the magnetocaloric unit and configured to transfer the heat transfer fluid using centrifugal force,
wherein the first fluid transfer device includes:
a first chamber configured to be rotatable relative to the magnetocaloric unit;
a first outlet connectable to an outer portion of the first chamber; and
a first inlet connectable to an inner portion of the first chamber, and
the second fluid transfer device includes:
a second chamber configured to be rotatable relative to the magnetocaloric unit;
a second outlet connectable to an outer portion of the second chamber; and
a second inlet connectable to an inner portion of the second chamber.

2. The magnetic cooling device of claim 1,
wherein the magnet is configured to be rotatable relative to the magnetocaloric unit, and a rotation of the magnet, the first chamber, and the second chamber is configured to be synchronized.

3. The magnetic cooling device of claim 2, further comprising:
a rotating shaft configured to rotate the magnet, the first chamber, and the second chamber together.

4. The magnetic cooling device of claim 1,
wherein the magnetic cooling device is configured to be switchable between a first mode configured to move the heat transfer fluid cooled by the magnetocaloric unit in a first direction and a second mode configured to move the heat transfer fluid heated by the magnetocaloric unit in a second direction opposite to the first direction.

5. The magnetic cooling device of claim 4,
wherein while the magnetic cooling device operates in the first mode, the magnet is configured to not apply a magnetic field to the magnetocaloric material, the outer portion of the first chamber is configured to communicate with the first outlet, and the inner portion of the second chamber is configured to communicate with the second inlet.

6. The magnetic cooling device of claim 5,
wherein while the magnetic cooling device operates in the first mode, the first outlet is configured to guide the heat transfer fluid discharged from the first chamber toward the magnetocaloric unit, and the second inlet is configured to guide the heat transfer fluid discharged from the magnetocaloric unit toward the second chamber.

7. The magnetic cooling device of claim 4,
wherein while the magnetic cooling device operates in the second mode, the magnet is configured to apply a magnetic field to the magnetocaloric material, the outer portion of the second chamber is configured to communicate with the second outlet, and the inner portion of the first chamber is configured to communicate with the first inlet.

8. The magnetic cooling device of claim 7,
wherein while the magnetic cooling device operates in the second mode, the second outlet is configured to guide heat transfer fluid discharged from the second chamber toward the magnetocaloric unit, and the first inlet is configured to guide heat transfer fluid discharged from the magnetocaloric unit toward the first chamber.

9. The magnetic cooling device of claim 1,
wherein the first chamber is configured, upon rotation, to communicate with one of the first outlet and the first inlet, and
the second chamber is configured, upon rotation, to communicate with either one of the second outlet and the second inlet.

10. The magnetic cooling device of claim 9,
wherein the outer portion of the first chamber and the inner portion of the first chamber are spaced apart along a radial direction and configured to have the same angular range with respect to a rotation center, and
the outer portion of the second chamber and the inner portion of the second chamber are spaced apart along the radial direction and configured to have the same angular range with respect to a rotation center.

11. The magnetic cooling device of claim 1,
wherein the first chamber is configured to selectively communicate with the first outlet and to always communicate with the first inlet, and
the second chamber is configured to selectively communicate with the second outlet and to constantly communicate with the second inlet.

12. The magnetic cooling device of claim 11,
wherein the first inlet comprises a plurality of first inlets arranged spaced apart along a circumferential direction,
the inner portion of the first chamber extends along the circumferential direction to communicate with all of the plurality of first inlets,
the second inlet comprises a plurality of second inlets arranged spaced apart along the circumferential direction, and
the inner portion of the second chamber extends along the circumferential direction to communicate with all of the plurality of second inlets.

13. The magnetic cooling device of claim 3,
wherein the first fluid transfer device includes:
a first rotating frame coupled to the rotating shaft and configured to be rotated by the rotating shaft, the first rotating frame including the first chamber;
a first fixed frame configured to accommodate the first rotating frame and including the first outlet; and
a second fixed frame configured to cover the first rotating frame accommodated in the first fixed frame and including the first inlet, and
the second fluid transfer device includes:
a second rotating frame coupled to the rotating shaft and configured to be rotated by the rotating shaft, the second rotating frame including the second chamber;
a third fixed frame configured to accommodate the second rotating frame and including the second outlet; and
a fourth fixed frame configured to cover the second rotating frame accommodated in the third fixed frame and including the second inlet.

14. The magnetic cooling device of claim 13, further comprising:
a first sealing member comprising a seal disposed between the first fixed frame and the second fixed frame; and
a second sealing member comprising a seal disposed between the third fixed frame and the fourth fixed frame.

15. The magnetic cooling device of claim 3,
wherein the first fluid transfer device, the magnet, and the second fluid transfer device are arranged along a longitudinal direction of the rotating shaft,
the first chamber and the magnet are not aligned with each other along the longitudinal direction of the rotating shaft, and
the second chamber and the magnet are aligned with each other along the longitudinal direction of the rotating shaft.
